(19) United States
(12) Patent Application Publication
(10) Pub. No.: US 2004/0128003 A1
(43) Pub. Date: Jul. 1, 2004

(54) SYSTEM AND METHOD FOR MODEL BASED CONTROL OF A NEURAL NETWORK

(76) Inventors: Nathaniel Frampton, Pearl River, LA (US); Eileen Heider, Budd Lake, NJ (US); Michael Miller, Shreveport, LA (US); Erika Valentine, Blanchard, LA (US); J. Michael Bearden, Benton, LA (US); Thomas A. McWilliams, East Stroudsburg, PA (US)

Correspondence Address: U.S. ARMY TACOM-ARDEC, ATTN: AMSTRA-AR-GCL, BLDG 3, PICATINNY ARSENAL, NJ, 07806-5000, US

(21) Appl. No.: 10/707,882

(22) Filed: Jan. 20, 2004

Related U.S. Application Data
(63) Continuation-in-part of application No. 10/064,542, filed on Jul. 25, 2002.

(51) Int. Cl. G05B 13/02

(52) U.S. Cl. 700/31

(57) ABSTRACT

A model based controller system and method is disclosed. The system and method includes at least one model including at least one process step, at least one controller that generates at least one control command, at least one component responsive to the at least one control command, wherein the at least one component receives the at least one control command from the at least one controller, and wherein the at least one component sends at least one component information element to the at least one controller, and at least one communicative coordination that communicatively coordinates the at least one model with the at least one controller, wherein the at least one control command is generated in accordance with the at least one process step, and wherein at least one of the at least one process step is varied in accordance with the at least one component information element.

### CROSS REFERENCE TO RELATED APPLICATIONS

This Application is a continuation-in-part of and claims priority of copending application Ser. No. 10/064,542, filed Jul. 25, 2002, the entire disclosure of which is hereby incorporated by reference as if being set forth herein in its entirety.

### FEDERAL RESEARCH STATEMENT

The inventions described herein have been developed for, pursuant to, or with the assistance of, the United States government. These inventions may be manufactured, used and licensed by or for the United States government for United States government purposes.

### BACKGROUND OF INVENTION

1. Field of the Invention

The present invention relates generally to control systems, and, more particularly, to a system and method for model based control of a neural network.

2. Description of the Background

In current industrial, manufacturing, and data processing environments, process control is often necessary in order to ensure proper operation, and repeatability, of a process. Process control may require the performance of a series of steps, such as in a particular order or at a particular time, in order to maintain a process within given tolerance levels, or to ensure process repeatability. Often, the result of a process is highly dependent on predefined tolerances subject to process control. Consequently, it is highly desirable, but difficult to accomplish, controls that are modified “on-the-fly” to maintain tolerances and the like, such as by a neural network.

Process controllers are often implemented in order to maintain processes within given tolerance levels. In a typical embodiment, a system is designed around controlling hardware or software that participates in a process. For example, control may be constructed around the programming of a physical component to perform step A at set point X, step B at set point Y and step C at set point Z. In such an embodiment, an error in the process that causes the non-occurrence of, for example, process variable 1 reaching set point X, may cause the non-occurrence of, for example, step A, until the process controller is reprogrammed to look for an alternative set point in order correct the problem.

Such programming for error control may typically be performed by a process engineer. The process engineer must be familiar with the particular programming language of the control unit at issue, and must further be aware of where the error problem has arisen within the code of that controller. The process engineer may then model a correction patch, and must then generate correction program code, in the language of the control unit at issue, for entry into the control unit by hard coding. In this scenario, a model is a mathematical algorithm that results in the suggestion of a corrected path based on inputs of the current process state. Thus, a process engineer must generate a model for correcting the error, must turn that model into the proper coding language, and must enter that coding language directly into the controller. Such an error correction requires extensive training for process engineers, and requires a great deal of human interaction and training in order to maintain processes within given tolerances.

Thus, a manufacturing base technology gap is caused by current industrial control solutions. Control solutions, including those presently termed “open,” are very limited in that those “open” solutions require extensive training, or the participation of a trained vendor, for the control solution. A Siemens or Allen Bradley PLC, for example, is vendor specific hardware, and the software correspondent thereto is useful only with that specific hardware, and may be reprogrammed or modified only by a dedicated consultant of that product, or by a process engineer trained specifically on that product. No integration with other vendors or manufacturing science is encouraged or enabled.

Similar statements could, of course, be made with regard to different computer programs or languages. Processes are completely contained within a particular control logic, either in that particular software program, or in a particular software as it relates to particular hardware. If one desires to manufacture another product using the particular software, or the hardware related thereto, for example, one needs to re-write control logic. Vendors have no interest in logic portability, which would allow the moving of a particular application or process from one vendor to another. Thus, manufacturing processes are not currently portable. If portability is only available to the same vendor hardware, or software, then there is no true portability, and hence no true “open” system. Without portability, designers cannot have confidence that parts can be manufactured consistently, in quantity, and to specification.

Designers need to be confident that manufacturers can produce products consistently, in quantity and to specification, and to meet scalability requirements. Manufacturing processes should be portable, scalable, and extensible, and hence the gap between the data from the manufacturing process and the designer capable of improving the process must be closed. Further, manufacturing engineers must be able to constantly improve the production process. Engineers should not be forced to use a high-end, expensive consultant from a particular controls company. Engineers should be able to make changes to the control system on the floor, and on the fly, preferably without stopping ongoing, money-making processes.

Thus, the need exists for a controller environment in which a model may be developed, and universally coordinated with a controller, without a requirement for extensive training or extended interaction from a process engineer or high-end consultant. Such a system may preferably provide for the development of a computerized model, wherein the computerized model, via a coordination interface, may intelligently select when control is necessary, and may interface with a controller operating in any controller language upon sensing that the model operation is necessary.

### SUMMARY OF INVENTION

Model Based Control, “MBC”, addresses manufacturing problems, caused, in part, by the shortcomings, nonrepeatability, and non-portability of controllers. MBC provides an advanced integrated development environment for creating actual controllers, a component wizard for virtualizing particular devices, an HMI for viewing applications, and may provide neural network integration. Two exemplary applications of the MBC are, from a process industry, a crystallization application, and from a discreet part manufacturing industry, a lathe application.”

The present invention is thus directed to a model based controller system including at least one model including at least one process step, at least one controller that generates at least one control command, at least one component responsive to the at least one control command, wherein the at least one component receives the at least one control command from the at least one controller, and wherein the at least one component sends at least one component information element to the at least one controller, and at least one coordination that communicatively controls the at least one model with the at least one controller, wherein the at least one control command is generated in accordance with at least one process step, and wherein at least one of the at least one process step is varied in accordance with the at least one component information element.

The present invention also includes a method of using a model based controller system to control a physical process, including generating at least one model including at least one process step, issuing at least at least one control command from at least one controller, receiving, by the at least one component, at least one control command from the at least one controller, sending, by the at least one component, at least one component information element to said at least one controller, a response to the at least one control command, and generating at least one coordination that communicatively controls said at least one model with the at least one controller, wherein the at least one control command is generated in accordance with at least one process step, and wherein at least one of the at least one process step is varied in accordance with the at least one component information element.

These and other advantages and benefits of the present invention will become apparent from the detailed description of the invention hereinbelow.

### BRIEF DESCRIPTION OF DRAWINGS

The invention will be better understood with reference to the following illustrative and non-limiting drawings, in which like references there-throughout designate like elements of the invention, and wherein:

FIG. 1 is a block diagram illustrating technology interactions

FIG. 2 is a block diagram of an aspect of the present invention;

FIG. 2A is a block diagram of an aspect of the present invention;

FIG. 3 is exemplary screen shots of an aspect of the current invention;

FIG. 4 is a block diagram illustrating interactions within the present invention;

FIG. 5 is a block diagram of the present invention;

FIG. 6 is a block diagram of the present invention;

FIG. 7 is a block diagram of the present invention;

FIG. 8 is a block diagram of the present invention;

FIG. 9 is a block diagram of the present invention;

FIG. 10 is a block diagram of the present invention;

FIG. 11 is a block diagram of the present invention;

FIG. 12 is a block diagram of the present invention;

FIG. 13 is a block diagram of the present invention;

FIG. 14 is a block diagram of the present invention;

FIG. 15 is an exemplary screen shot of an aspect of the present invention;

FIG. 16 is an exemplary screen shot of an aspect of the present invention;

FIG. 17 is an exemplary screen shot of an aspect of the present invention;

FIG. 18 is a block diagram of an exemplary flow of an aspect of the current invention;

FIG. 19 is a block diagram of the present invention;

FIG. 20 is a block diagram of the present invention;

FIG. 21 is an exemplary screen shot of an aspect of the present invention;

FIG. 22 is a chart illustrating an aspect of the present invention;

FIG. 23 is a block diagram of the present invention;

FIG. 24 is an exemplary screen shot of an aspect of the present invention;

FIG. 25 is an exemplary screen shot of an aspect of the present invention;

FIG. 26 is an exemplary screen shot of an aspect of the present invention;

FIG. 27 is a block diagram of an aspect of the present invention;

FIG. 28 is a chart illustrating a list of exemplary components of an aspect of the present invention;

FIG. 29 is a block diagram of an aspect of the present invention;

FIG. 30 is a block diagram of the present invention;

FIG. 31 is an exemplary screen shot of an aspect of the present invention;

FIG. 32 is an exemplary screen shot and block diagram of an aspect of the present invention;

FIG. 33 is a flow diagram of an aspect of the present invention;

FIG. 34 is a list-diagram of an aspect of the present invention;

FIG. 35 is a list-diagram of an aspect of the present invention;

FIG. 36 is an exemplary screen shot of an aspect of the current invention;

FIG. 37 is an exemplary screen shot of an aspect of the current invention;

FIG. 38 is an exemplary screen shot of an aspect of the current invention;

FIG. 39 is an exemplary screen shot of an aspect of the current invention;

FIG. 40 is an exemplary screen shot of an aspect of the current invention;

FIG. 41 is a screen shot of an opening of an exemplary application of the current invention;

FIG. 42 is an exemplary screen shot of an aspect of the current invention;

FIG. 43 is an exemplary screen shot of an aspect of the current invention;

FIG. 44 is an exemplary screen shot of an aspect of the current invention;

FIG. 45 is an exemplary screen shot of an aspect of the current invention;

FIG. 46 is an exemplary screen shot of an aspect of the current invention;

FIG. 47 is an exemplary state diagram of an aspect of the present invention;

FIG. 48 is an exemplary state diagram of an aspect of the present invention;

FIG. 49 is an exemplary state diagram of an aspect of the present invention;

FIG. 50 is an exemplary state diagram of an aspect of the present invention;

FIG. 51 is an exemplary state diagram of an aspect of the present invention;

FIG. 52 is an exemplary flow diagram of an aspect of the present invention;

FIG. 53 is an exemplary screen shot of an aspect of the present invention;

FIG. 54 is an exemplary flow diagram of an aspect of the present invention;

FIG. 55 is an exemplary hardware embodiment of an aspect of the present invention;

FIG. 56 is an exemplary block diagram of an aspect of the present invention;

FIG. 57 is an exemplary screen shot of an aspect of the present invention;

FIG. 58 is an exemplary block diagram of an aspect of the present invention;

FIG. 59 is an exemplary screen shot and block diagram of an aspect of the present invention;

FIG. 60 is an exemplary diagram of an aspect of the present invention;

FIG. 61 is an exemplary diagram of an aspect of the present invention; and

FIG. 62 is an exemplary diagram of an aspect of the present invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in a typical control system and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

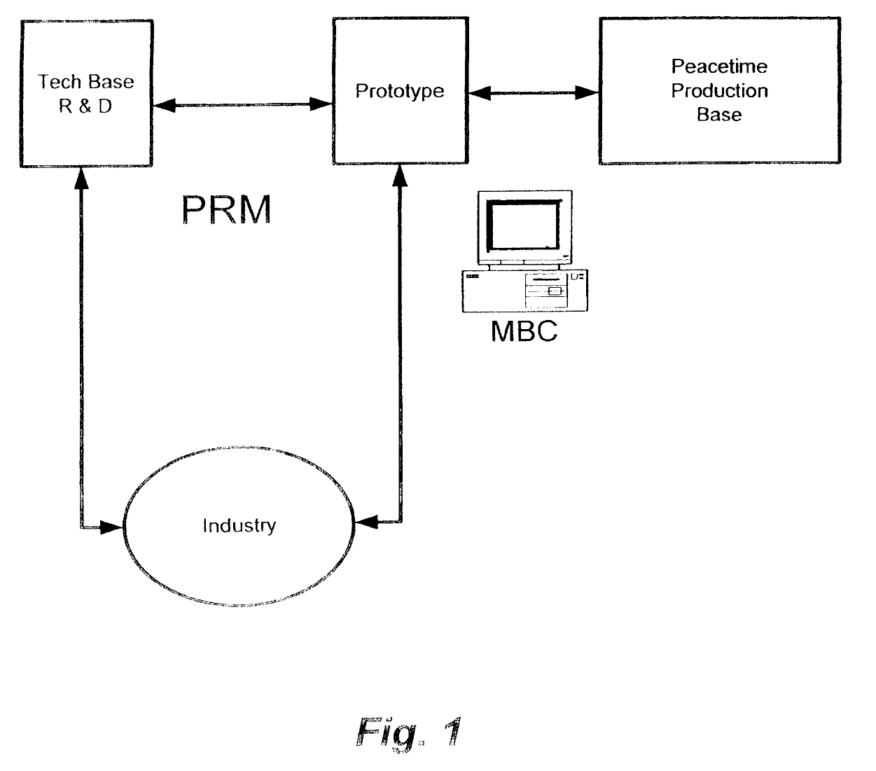

FIG. 1 is a flow diagram illustrating a product realization model wherein academia, industry, and/or government entities participate in research and development. That research may flow to the prototyping stage, and those prototypes may flow into production.

Variations from the prototyping environment in the production environment, such as different equipment or different operators, may cause catastrophic failure in the production process. The portability of the model used to generate a prototype, independent of the environment in which the model is used, is herein termed “model based control”. Model based control may provide an environment-independent control mechanism for direct portability of a prototype into consistent production at multiple production sites. Thereby, model based control provides for reproducibility and reliability by eliminating environmental variability, and hence provides for reduced development time to scale from research to pilot to production. Model based control is thus an open combination of devices, controls, and models used to reproducibly direct a system.

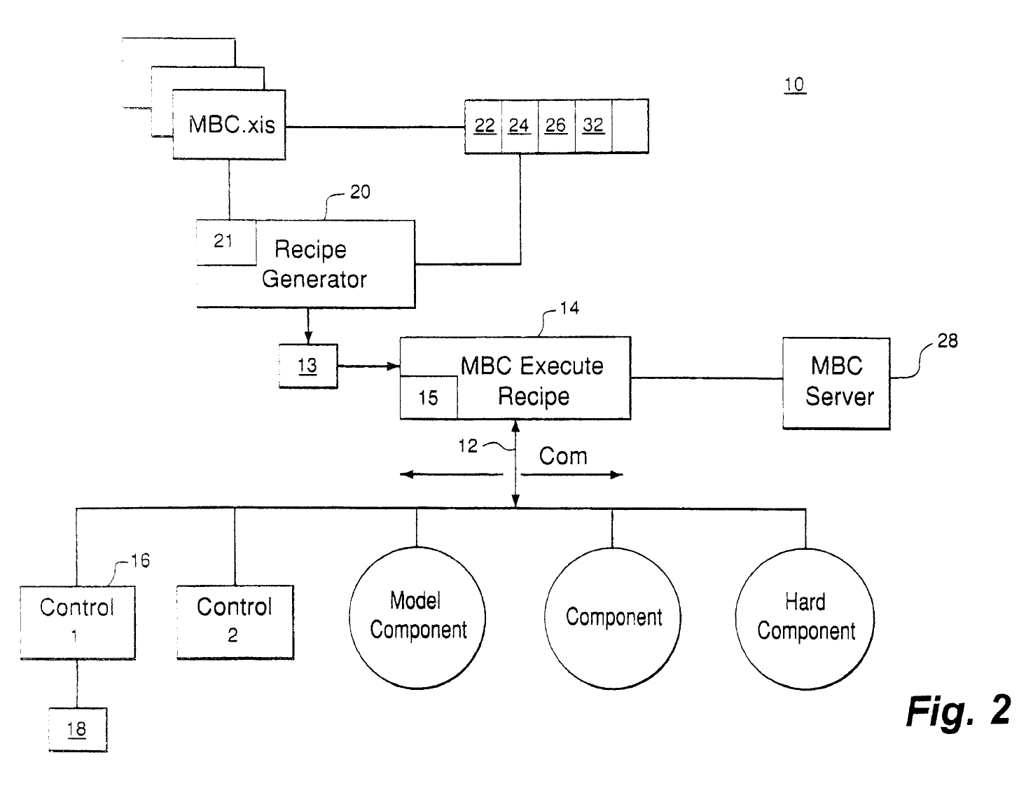

FIG. 2 is a block diagram illustrating a model based controller (“MBC”) system 10 in accordance with the present invention. The MBC system (10) may provide a coordination environment 12 that coordinates information flow, such as data flow, between at least one model 13 and at least one controller 16. The controller 16 may include, or may control, at least one additional component 18. The MBC 10 may include a plurality of environments, such as an executor 14 and a development environment 20. The development environment 20 may include an application integrated development environment (“IDE” or “AIDE”) 21 and at least one execution platform 15. Within, or associated with, the IDE 21 and/or the executor 14, the MBC 10 may additionally include a framework 22, a runtime platform 24, a recipe generation and/or edit platform 26, and at least one server 28, such as a coordination environment server. The at least one server 28, or server programs associated with the server, may be platform and/or operating system independent, such as OPC, DCOM, or XML. The development environment 20 and executor 14 may additionally include other facilities to control simulated or hardware components for, for example, real time control. The executor 14 may follow a code generation/compilation behavior, or an interpreted or CLR expression behavior, as alluded to further hereinthroughout.

In an exemplary embodiment of an MBC application, discussed in more detail hereinbelow, there may exist an agitator, a valve control, and/or a water jacket. Component(s) may be created in the development environment which represent the agitator, valve or water jacket, and which include a set of function calls specific to each, such as to set the agitator speed, turn it on, turn it off, and/or interface it to models. The executor resides above these components and coordinates the components in a recipe that applies model(s) which apply these function calls, which recipe may be developed using the development environment. The infrastructure for this coordination, and its effects on the actual components, may use the defacto standard of COM from Microsoft, for example.

The model, or models, mentioned in the above example are a simple equation, or equations, derived from first principals, such as those in a physics book, or based on empirical data or instructions, such as models generated based on watching a process run, or by watching an operator run a process, which empirical data may suggest a next action for a control system. Model based control thus includes combining hardware devices, control laws, and instruction sets into interoperable models to direct a system.

A component, as used herein throughout, includes a collection of function calls to a library, which function calls may be incorporated to one or more models. A model based control component may thus include a library that interfaces to an actual device that has functions, and a model that has or calls functions.

If an existing controller is operational, models in a model based control leverage the existing controller to: provide integration of complex models; isolate the process logic from the device logic to ensure that the logic is portable; apply appropriate technologies to a solution; embrace industry defacto standards; and prioritize usability by the process engineer to design and build control systems. This leveraging of existing controllers may greatly expedite, and greatly reduce the cost of, for example, retrofitting aging processes without changing out all controllers and equipment. Additionally, leveraging of existing and operational controllers simplifies implementation of new processes that access aging equipment and facilities, as well as allowing for performance gauging of aging processes and equipment. The leveraging of existing controllers and running processes also allows for prototyping, calibration, testing and simulation capabilities.

Returning now to FIG. 2, the coordination environment 12 may be, for example, a server or software thereon, such as an interface, that coordinates data flow between the at least one model 13 and an at least one controller 16. The coordination environment 12 receives and processes commands from the model 13 to control the controller 16, and receives and processes information received from the controller 16 for placement into the model 13, thereby allowing the model 13 to monitor and control a process via the coordination environment 12.

FIG. 2A is a graphical illustration of a coordination environment 12 in accordance with the MBC system 10 of FIG. 2. The coordination environment 12 may coordinate at least one of a plurality of models 13 instructing at least one of a plurality of available controllers 16, as set forth hereinabove, such as over a network 100, and such as by interfacing through the at least one server 28. For example, the at least one model 13 may be one of a plurality of models within a recipe, and the at least one controller 16 may be one of, for example, a plurality of programmable logic controllers each having alarms and/or controls associated therewith, or one of a plurality of input-output (I/O) ports within, or associated with, a programmable logic controller, or a controllable hardware device, for example. The at least one model 13 may be remote from at least one of the coordination environment 12 and the control level 16, and each element of the MBC 10, namely at least the model 13, coordination environment 12, and the control level 16, may exist in hardware or computer programming, such as on the at least one server 28. The at least one server 28 may be capable of remote communications, such as over a network, such as the internet. Thus, the ability of the MBC 10 to control a process, or to engage in logic, may be a function of the data rate capabilities of the network, servers, and the like, associated with the MBC 10.

Returning now to FIG. 2, the IDE via, for example, a connection via service 28 to a network, may enable recipe-to-recipe control on a single node. The IDE may include the infrastructures to support this control and to allow multiple recipes to be viewed within the IDE. A remote networking viewing of the recipes may allow recipes to be viewed, during execution, on a local machine and/or from remote machines, and may thus allow recipe-to-recipe control between network nodes. The IDE infrastructures thus support node-to-node recipe control, and the IDE supports network recipe selection and control and enhances code generation to ensure support of node designation of a recipe.

Further, a distributed MBC architecture may allow individual device controllers to run on individual nodes, thereby necessitating an integrated development environment on each node to create the internodal, distributed device controller. Individual node control of one recipe to another is thus provided by MBC, thereby allowing hierarchies of control between recipes, and thereby allowing for remote viewing across the network of any particular recipe running. In such a distributed embodiment, the master recipe creates and controls hierarchical relationships to other recipes, across nodes and across the network. Thus, for example, the master recipe may be coordinating three recipes, and one of those recipes may be coordinating two others, thereby creating hierarchies across the network, and thereby allowing for a distributed MBC that may, for example, perform plant-wide, and/or system wide, control.

The development environment 20, such as the IDE 21, may allow for the development of or review of a pre-existent recipe or a recipe generated from, for example, the recipe generation platform 26, for execution on the execution platform. Thus, the development environment 20 may allow for attachment directly to a running controller 16, or over a network to a running controller 16, for review and editing of the pre-existent recipe on that running controller 16, or may allow for creation of a new recipe to run the at least one controller 16, or may allow for direct control of any MBC component, such as an I/O device. The development environment 20 preferably treats a controller 16 as an object for control by at least one model 13, thereby eliminating the need to hard code selected set points into the controller 16 itself. In this manner, the development environment 20 can use the model 13 to vary the controller 16 as an object, and alter the desired set points. The relation of the model 13 to the controller 16 as an object makes obvious to a user, such as a process engineer, the coordination between the controller 16 and the model 13, unlike the hard coding relationship of the prior art.

The IDE 21 may allow for extensions via a component object model, such as a (COM) or XML Service, for example, to enable the control of numerous different components via the same, or an associated, MBC 10. The development environment 20 may, for example, present a plurality of selectable, i.e. registered, components, and/or preexistent model components, as discussed further hereinbelow, which may, for example, be dragged and dropped into a developing recipe project. The development environment 20 may include, for example, programming in Visual Basic, Visual C++, such as a (COM), or XML Services and/or Microsoft Windows 2000 Professional.

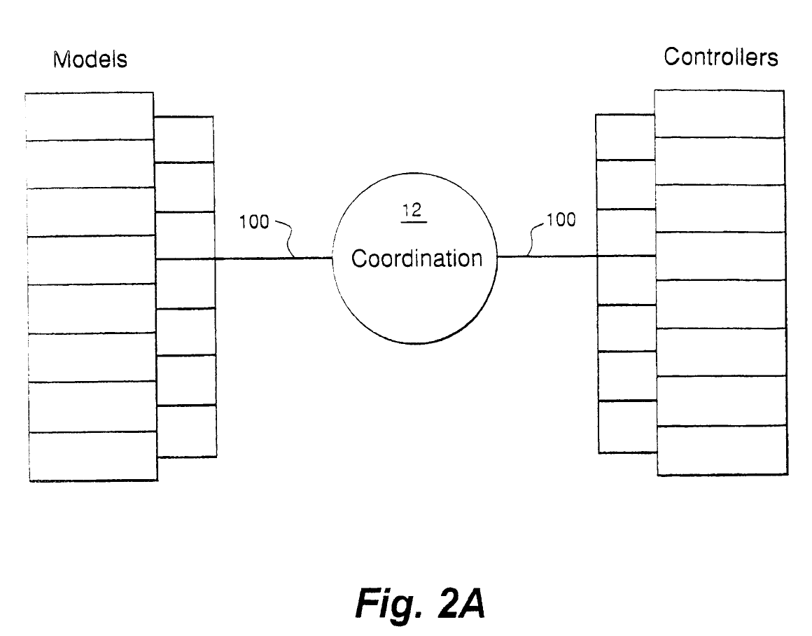

The development environment 20 may additionally include, such as within or associated with the IDE 21, a recipe edit platform 26 of the IDE 21, which may allow the viewing and editing of at least one running recipe, or of at least one recipe project created within the IDE 21. The recipe edit platform 26 may allow, for example, the entry of multiple recipe steps, the reordering of steps, pre and post step work, looping and branching control, timing controls, and the like. The recipe edit platform may allow for drag and drop, right click menus, pop up menus, or menus displayable by activation of, for example, functional keyboard keys, which menus may include help instructions to perform functions within a recipe, editing or monitoring of time for a loop within the recipe or for a step within the recipe, and/or tabbed views, such as a recipe tree, a recipe sheet, and/or a recipe code window, for example. Each step within the recipe may be accessible within a window for editing of each recipe step, as illustrated in the exemplary screen shots of FIG. 3.

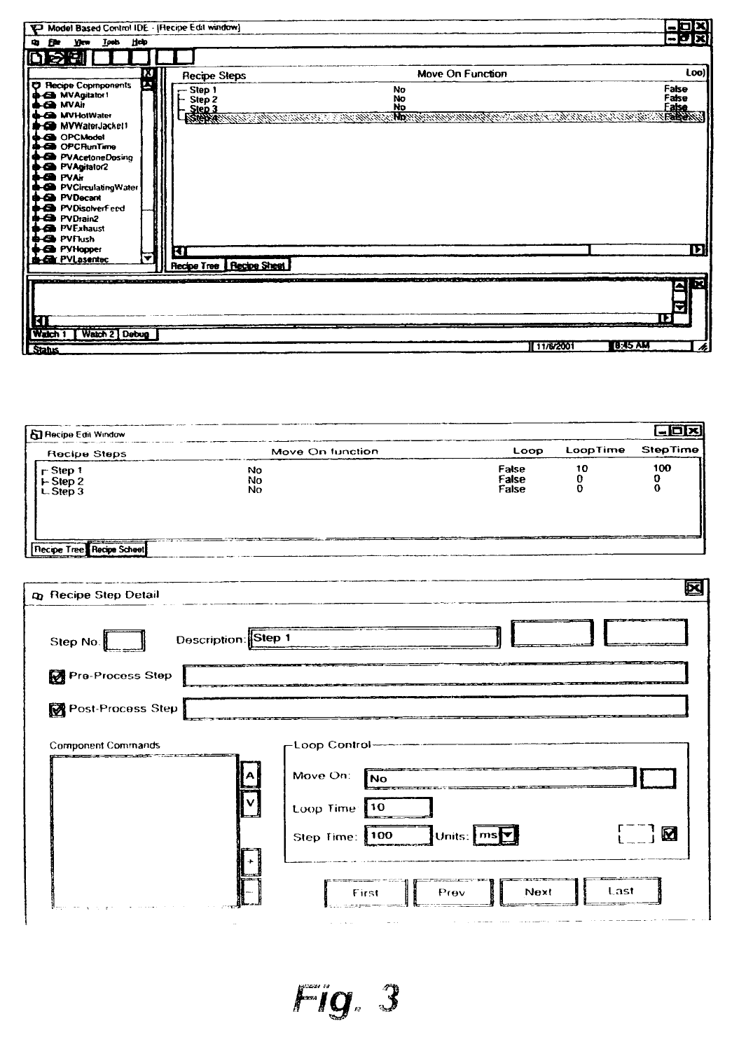

As shown in FIG. 3, MBC recipe development accesses MBC components. MBC components may be created, as discussed herein, using a programming language that supports Microsoft's Component Object Model (COM) platform, for example, such as Microsoft Visual Basic (VB) and Microsoft Visual C++. A COM library executable may host the MBC components as discussed hereinabove, and the COM library may be registered with MBC, such as at the command line using the component's self-registering capability, or by using an MBC Browser utility, as illustrated in FIG. 4.

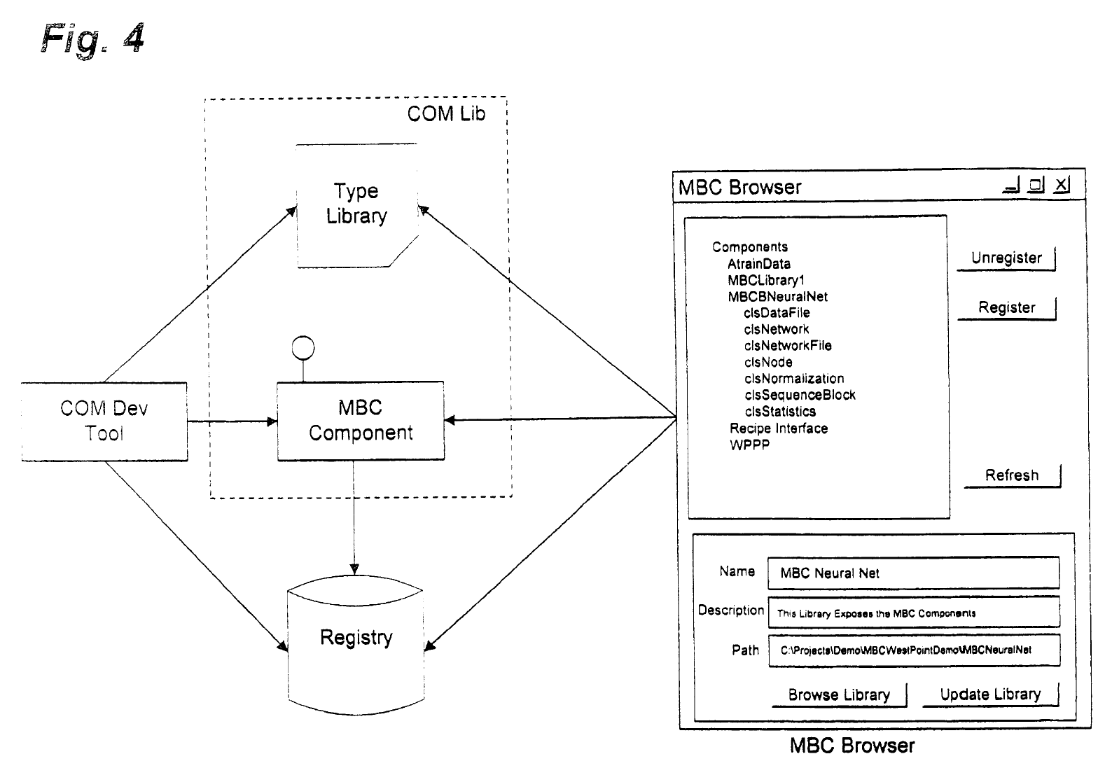

FIG. 5 illustrates an exemplary IDE workflow associating a recipe, a component, and the IDE. The IDE creates recipes that coordinate components, and the IDE uses these components, such as by heuristic modeling, to further develop recipes. MBC components may, as discussed hereinabove, preferably be COM objects that have been registered with the MBC, and MBC recipes may preferably be executables, such as Win32 executables.

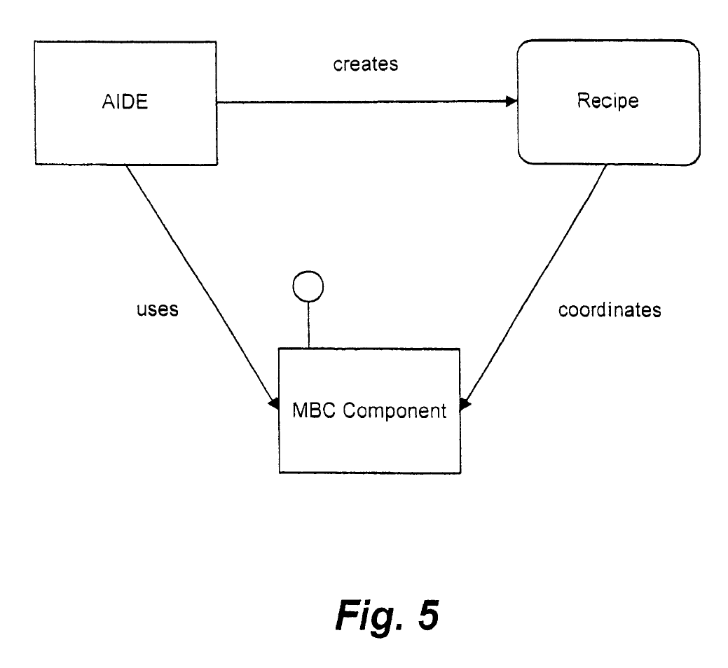

The AIDE may store recipes as structured text files herein referred to as an MBC Recipe Project (MRP). AIDE may provide the ability to generate the recipe executables based on the MRPs. When a recipe executable is generated, it may also be registered for use by MBC, as shown in FIG. 6 and as discussed hereinthroughout. Once a recipe has been registered with MBC, it can be used by or within other recipes.

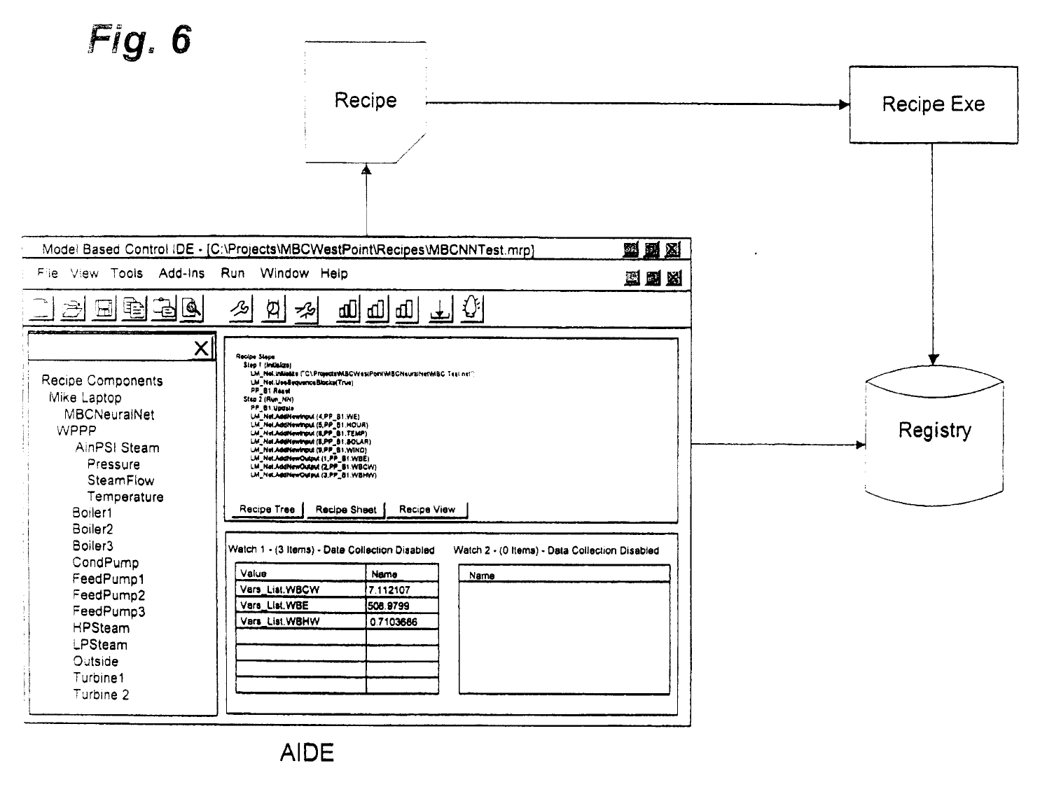

An MBC Object Manager (MOM) 77 may be used to enumerate, load, and/or connect to MBC recipes, as illustrated in FIG. 7. AIDE may receive its list of recipes from MOM. That is, upon request, MOM may return the list of registered MBC recipes in the registry.

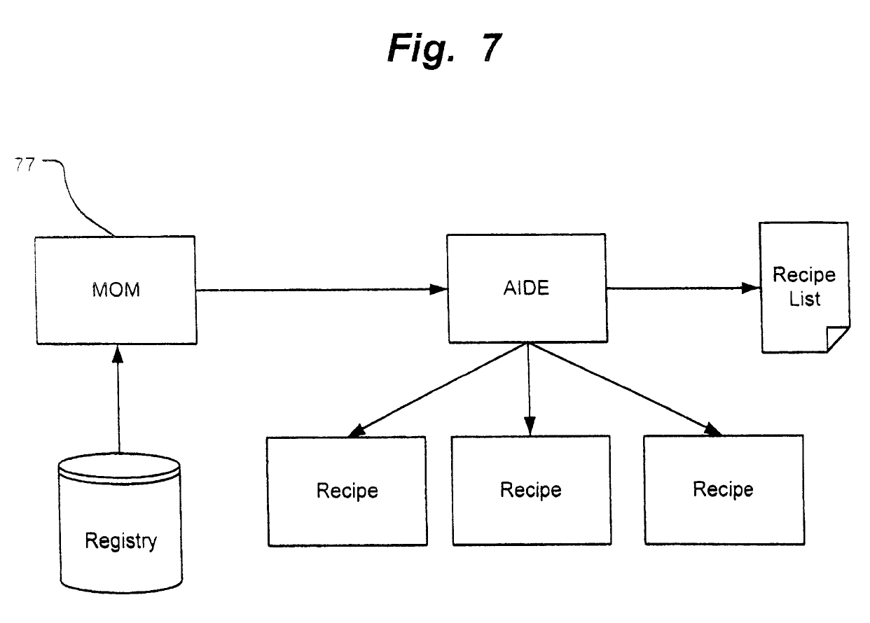

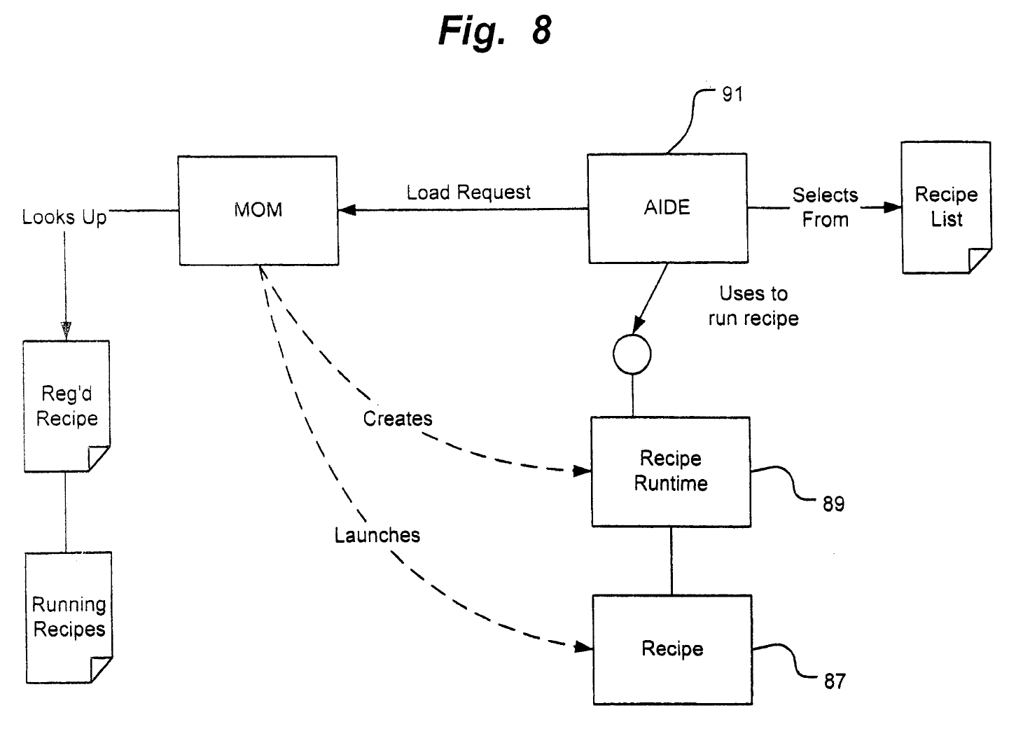

MOM 77 may also create and host recipe runtimes. AIDE, in order to run a recipe, may send a request to MOM to load the desired recipe. MOM may look up the recipe in its list, and, if MOM finds the requested recipe, MOM may launch the recipe executable 87, create a runtime interface for the recipe 89, and return the runtime interface to AIDE 91, as illustrated in FIGS. 8 and 9.

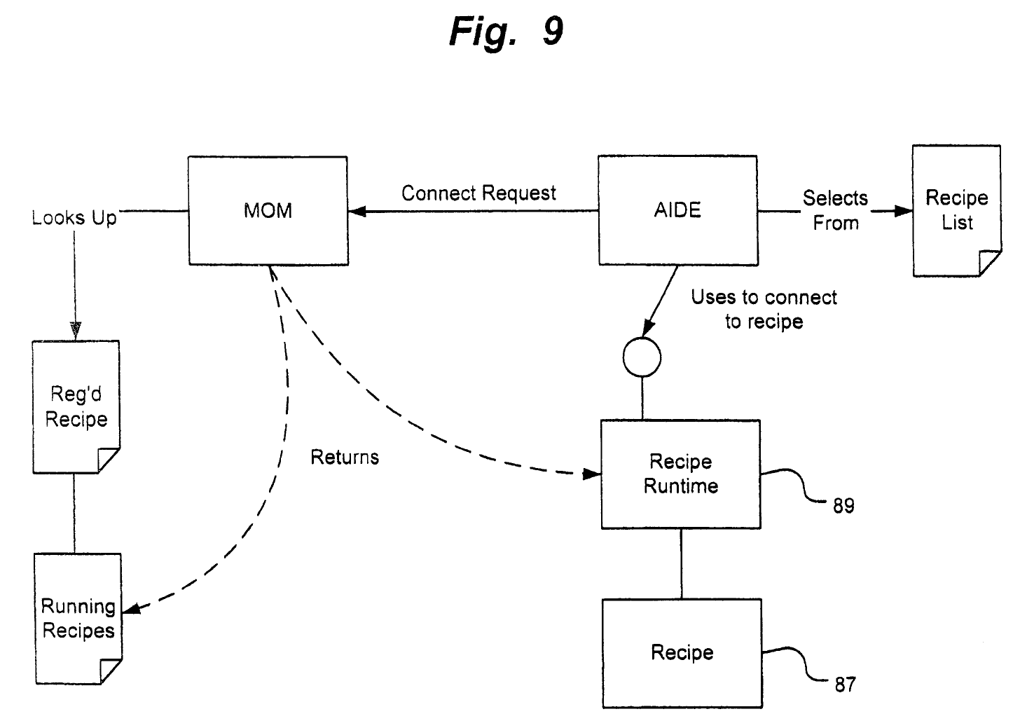

A recipe may directly use MOM. When a recipe is started, the recipe may request a runtime from MOM. If the recipe contains a reference to another recipe, then the first recipe may use MOM to load that other recipe, and may then use the runtime object returned by MOM to run that other recipe 101, as shown in FIG. 10.

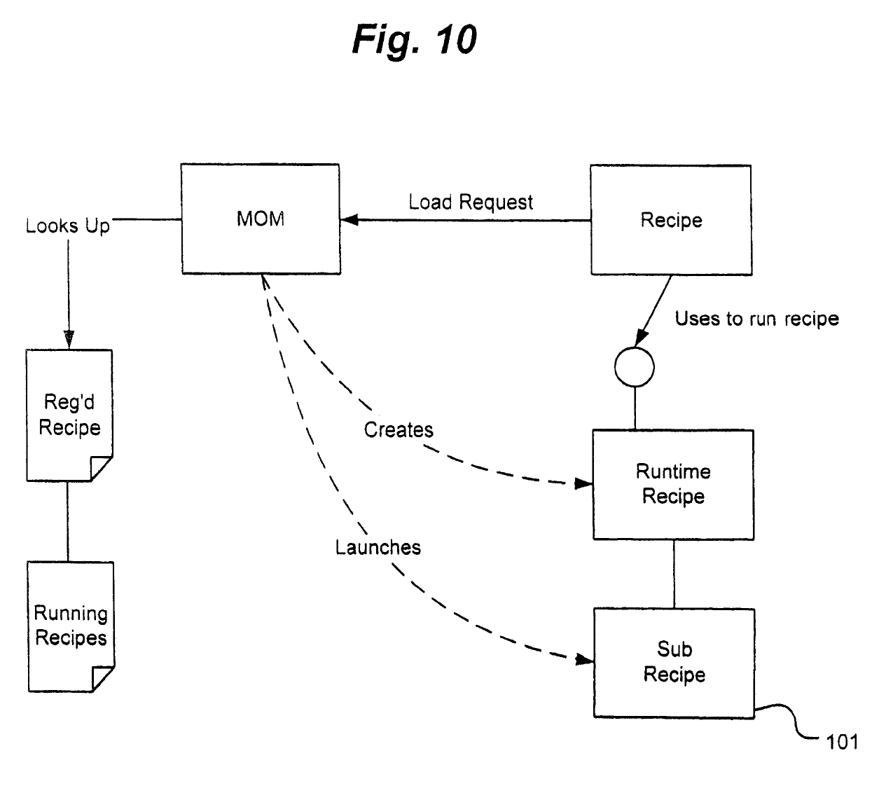

Thereby, remote recipe execution as discussed hereinthroughout may be done using MOM. When AIDE is to launch or connect to a remote recipe, it may access MOM, enumerate hosts on the network, and locate the MOM running on each remote host. Once the connection to a remote MOM has been established, AIDE may use the same mechanism to launch and connect to remote recipes that is used locally 111, as shown in FIG. 11.

MBC recipes may use and/or access a combination of local and remote recipes. When a recipe contains a reference to a remote recipe, the remote host name may be contained within the reference. This allows the recipe to locate MOM, and request that MOM load the recipe remotely.

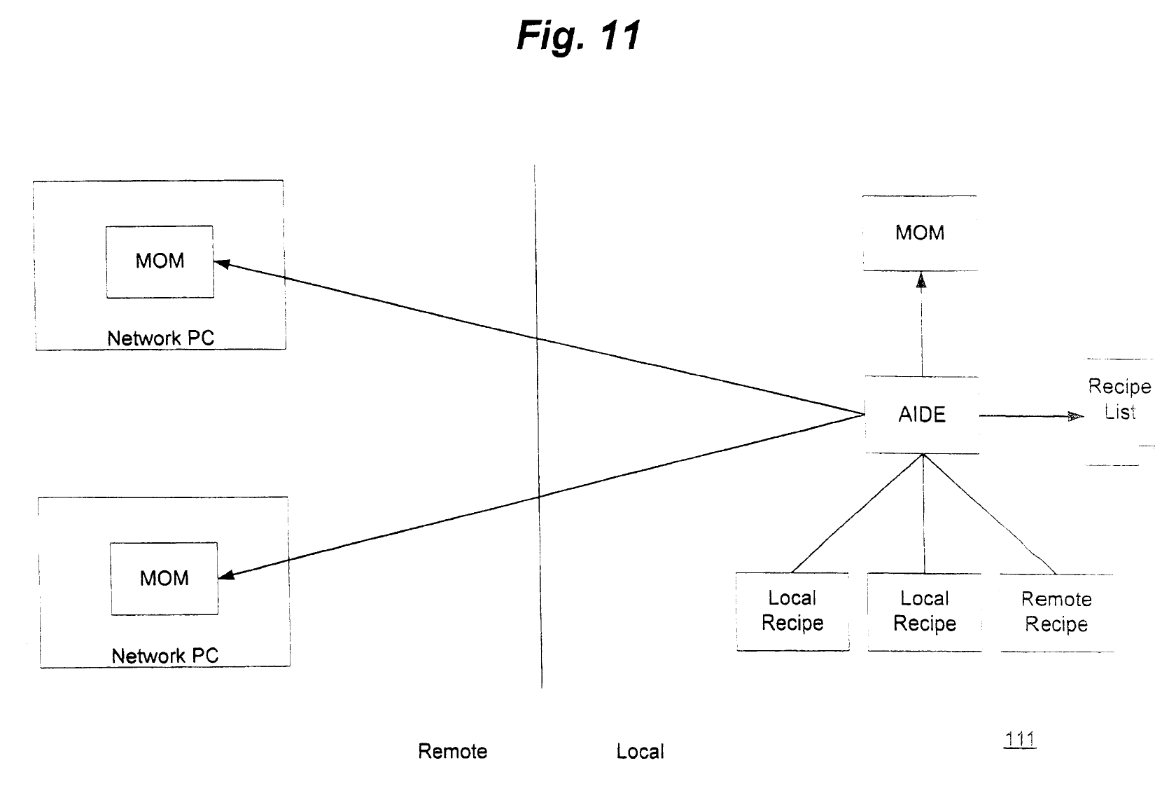

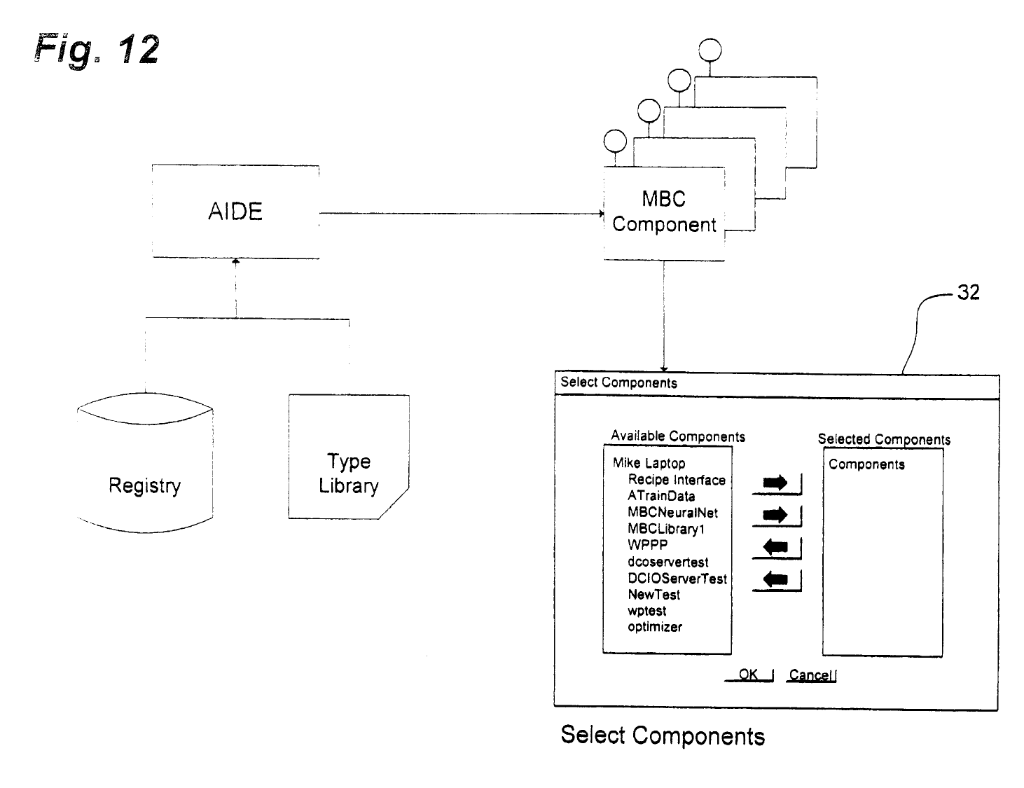

MBC recipes may be created using the list of components and recipes registered with MBC, and FIG. 12 illustrates how MBC components may be enumerated by the AIDE, such as in a component browser 32. FIG. 13 illustrates the enumeration of registered recipes by the AIDE. As illustrated, MBC components may be enumerated, for example, using a combination of the Windows Registry and COM Type Libraries 131. The registry may hold a list of MBC components, and information on the location of each component's type library. MBC recipes may be enumerated using the MOM, as discussed further herein. When requested, MOM may return a list of registered MBC recipes as discussed hereinabove.

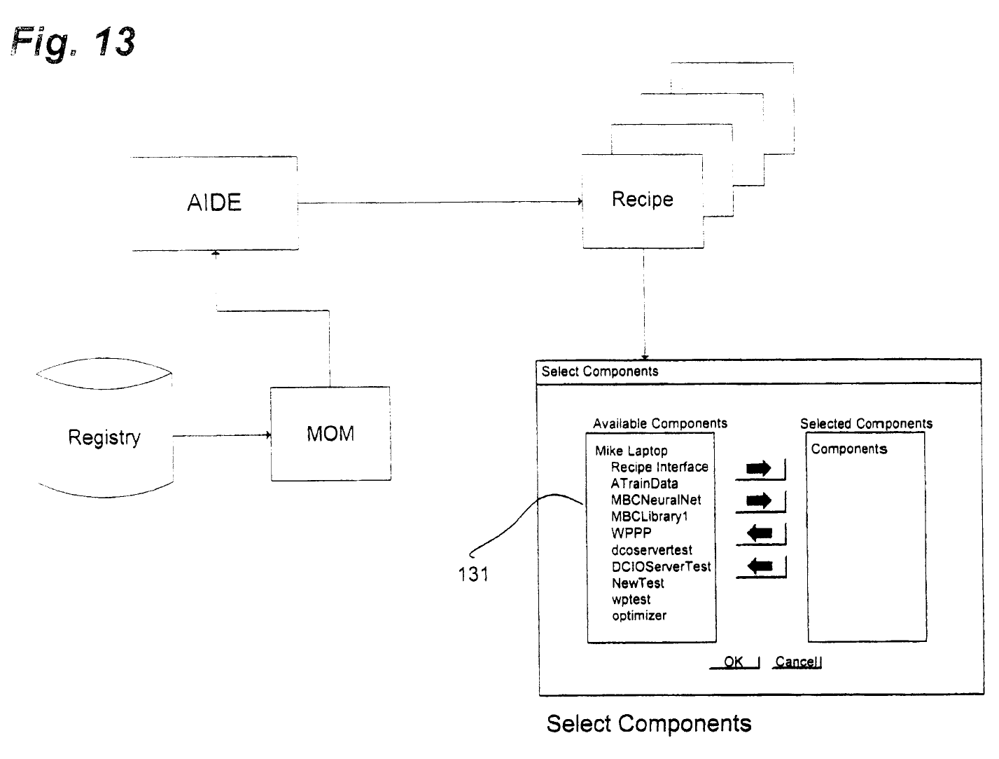

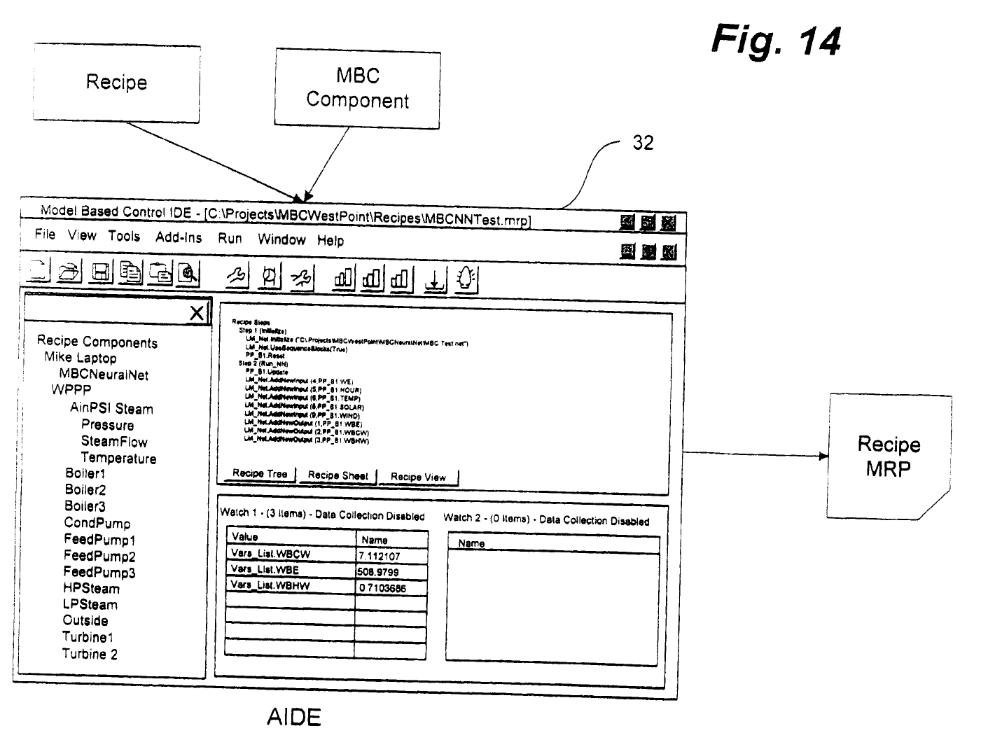

AIDE may use discovery and enumeration to construct a Select Components dialog, which may be, or may be within, a component browser 32, as shown in FIG. 14. The component libraries may be enumerated using the MBC registry entries, and the components within a library may be enumerated using the library's COM type library information, for example. MBC recipes may be created by combining registered MBC components and recipe executables. Items selected from the Select Components dialog may be used to create the recipe component list, as shown in FIG. 15. MBC components and recipe executables may provide interfaces that consist of methods and properties, which can be used to create recipe steps.

Returning now to FIG. 2, the development environment 20 may further include, as discussed hereinabove, the component browser 32. The component browser 32, as illustrated in the exemplary screen shots of FIG. 15, may display the components that have been, or may be, selected for a current recipe project in development. The component browser 32 may allow for selection of components, or of operational methods for components, for use in recipe steps, and/or for selection of components or component properties for display within certain windows. These display windows may include a watch window for watching an ongoing or active recipe, which watch window may illustrate, for example, true or false real time status of at least one selected recipe step condition, or a data collection window for watching active data accumulation, which data collection window may provide a capability to save data, such as a non-overwriteable date/time stamped save. The component browser 32 may provide a tree representation of components, for example, and may additionally provide the methods and/or properties of the components, including, for example, the component parameters, data types and/or property data types, of the displayed or selected components.

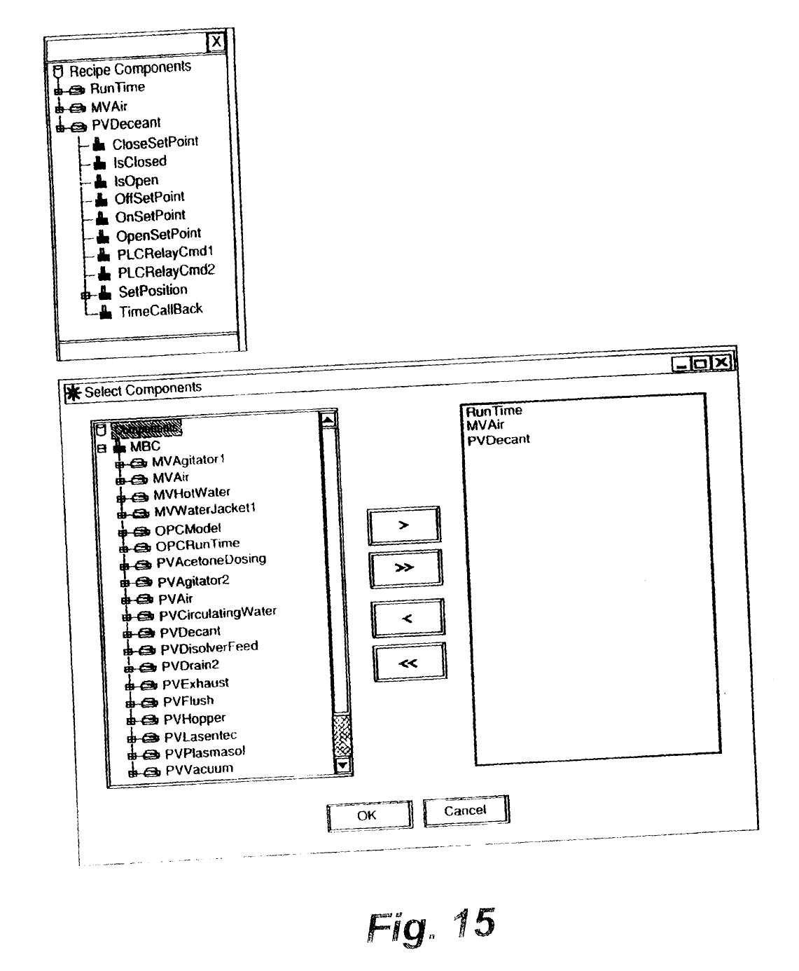

Within the integrated development environment, a user may view multiple recipes developed within the integrated development environment. In the illustration of FIG. 16, a master demo recipe 161 is referring to the demo run time 163, which is an interface to a demo recipe, and the master demo recipe is controlling a process 167, setting its mode, telling it to run, and observing the running, for the interfaced demo recipe. A demo recipe 169 may be developed using actual empirical data, thereby allowing development in the development environment based on real data. Further, the MBC may include a help menu for integrated development environment, which help menu may include step by step tutorials, for example. Additionally, the remotely accessible nature of the MBC via multiple nodes may allow web-based training using, in part, these tutorials, for example.

The development environment 20, and/or the executor 14, may share a simulator, wherein the simulator may include template operational methods of a plurality of hardware elements. A recipe may be developed using the available simulated hardware components, which simulated components, upon execution of the recipe, provide feedback that simulates the actual hardware that provides the basis for the simulated hardware. The behavior of the simulated components may be experimentally defined, such as by monitoring of actual hardware and saving performance data to simulator files. These simulator files may then be accessible to, or downloaded to, the MBC 10 as selectable components. Simulation and model development, based on real data, are discussed further hereinbelow.

The executor 14 is a component that coordinates hardware devices, commercial controllers and models to realize a particular control solution. The executor 14 is an environment that executes developed recipes for real world, or prototyping, solutions.

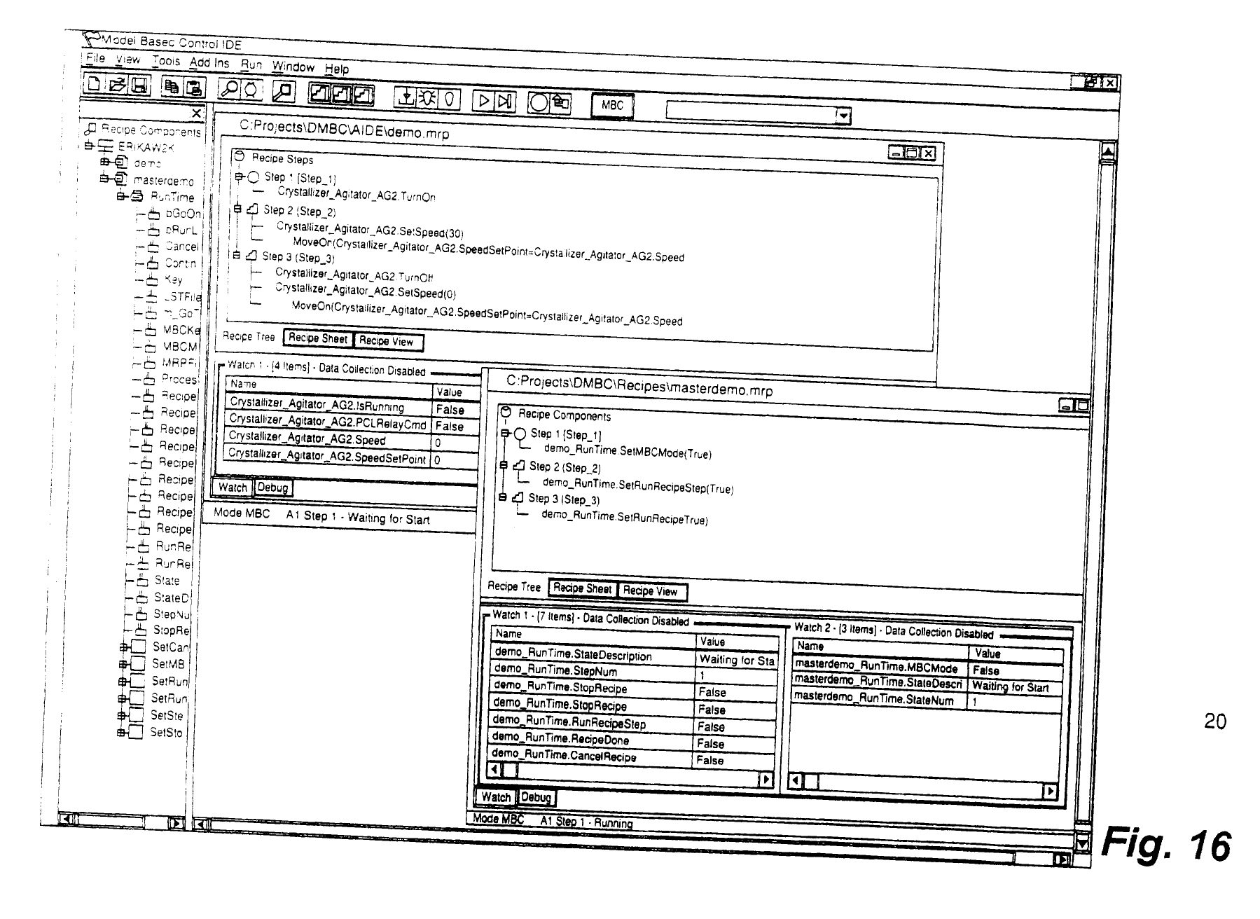

FIG. 15 is an exemplary screen shot illustrating component selection available within the component browser 32. Components may be selectable, for example, using point and click methodologies, treed methodologies, file menu methodologies, or may be imported via, for example, drag and drop and/or right click methodologies. The component selection module within the component browser 32 may allow for selection of components recognized by, and/or registered with, the operating system, or the MBC, as MBC components, and may allow for component selection for recipe projects. In the treed format illustrated in FIG. 17, component libraries 171, and components included therein, may be selectable from the tree. Component selection may be used during recipe creation, or when adding components to an existing recipe.

The framework 22 may provide functionality within the environments of the MBC 10, such as the development environment 20 and the executor 14. For example, the framework 22 may provide Open/Close/Save for recipe projects, or recipe files, within a recipe; the addition, or undo, of at least one component to a recipe; drag and drop, and/or cut and paste, from window to window within the MBC, and/or to or from exterior applications via, for example, importation to the MBC 10; execution command for running at least one recipe; debug of components or at least one recipe; Open/Close for windows such as recipe watch, data collection, recipe viewer, etc.; and support, such as at least one help menu. In order to provide these functions, the framework 22 may include system menus, system help, IDE window coordination, and/or toolbars, as will be apparent to those skilled in the art. Further, as used herein, toolbar, single arrow, double arrow, file menu, drop down menu, hyperlink, tab menu, or treed menu, for example, may be used interchangeably unless otherwise noted, and are provided by the framework 22. In an exemplary embodiment of a window provided in the framework 22, FIG. 17 is a screen shot illustrating primary interfaces for a recipe development session, such as within the development environment 20.

Each recipe developed and/or executed in the present invention may implement at least one model 13, as discussed hereinabove. Each recipe that includes at least one model 13 may monitor at least one method, process, or data flow, for example, wherein each model 13 within the recipe may control and/or monitor at least one aspect of the method, process, or data flow, for example. For example, a recipe may be generated to control the growth of a given crystal. Each model within the recipe may then monitor and/or control a particular aspect of the growth of the crystal.

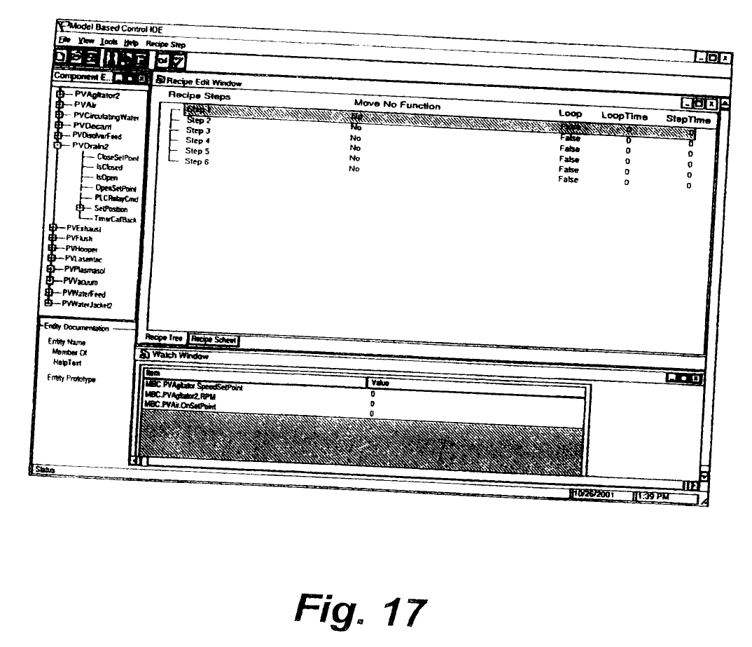

In this exemplary embodiment, the crystal may grow over time, preferably within a given tolerance for growth rate, which tolerance is monitored and controlled with improved consistency through the use of the present invention. For example, as illustrated in FIG. 18, a recipe A including twelve models that control the growth of the crystals, which recipe A may, at predetermined times, and/or at predetermined intervals, call models B and C, wherein models B and C may monitor particular aspects of the given crystal growth within the process controlled by master recipe A. Thus, for example, if model A monitors that the crystal growth is occurring too quickly, recipe A may run model F, wherein model F may provide process temperature change suggestions in order to bring crystal growth back within tolerance levels. However, for example, if recipe A monitors that crystal growth is occurring too slowly, recipe A may run model G, wherein model G may suggest the input of a particular gas in order to stimulate growth of the crystal, and wherein model G may call model F to suggest temperature changes to stimulate crystal growth. Additionally, as will be apparent to those skilled in the art, recipe A may then call model D, model E, and model J, each individually, in sequence, or all simultaneously, such through the use of object oriented programming. Thereby, the recipe may provide real time process control over the growth of the crystal, and tolerance levels may be maintained more consistent throughout repetitions of the process through the use of the same coordination environment. More specifically, with respect to this exemplary crystallizer MBC application, the controller may control the feed from a dissolver tank of material down into a crystallizer, and maintain a constant temperature. Basic agitation may be done with a motor that extends a paddle down into the crystallizer, and a valve may control the amount of feed coming from the dissolver.

An operator may manually run the crystallizer system. The operator can control the system, but overshoots of the required temperature in the system, when the system was operated manually by an experienced operator, were about 3.6 degrees, and undershoots about 2.9. This overshoot and undershoot is obviously very dependent on the experience of the operator. Inexperienced operators may improve over time, but a particular operator gaining expertise is a fundamental problem in transferring a particular process. The operator may have difficulty in compensating for line and heat loss, valve overshoots, and, as rising temperature increases volume in the tank, it may become difficult for the manual operator to compensate for energy into the tank.

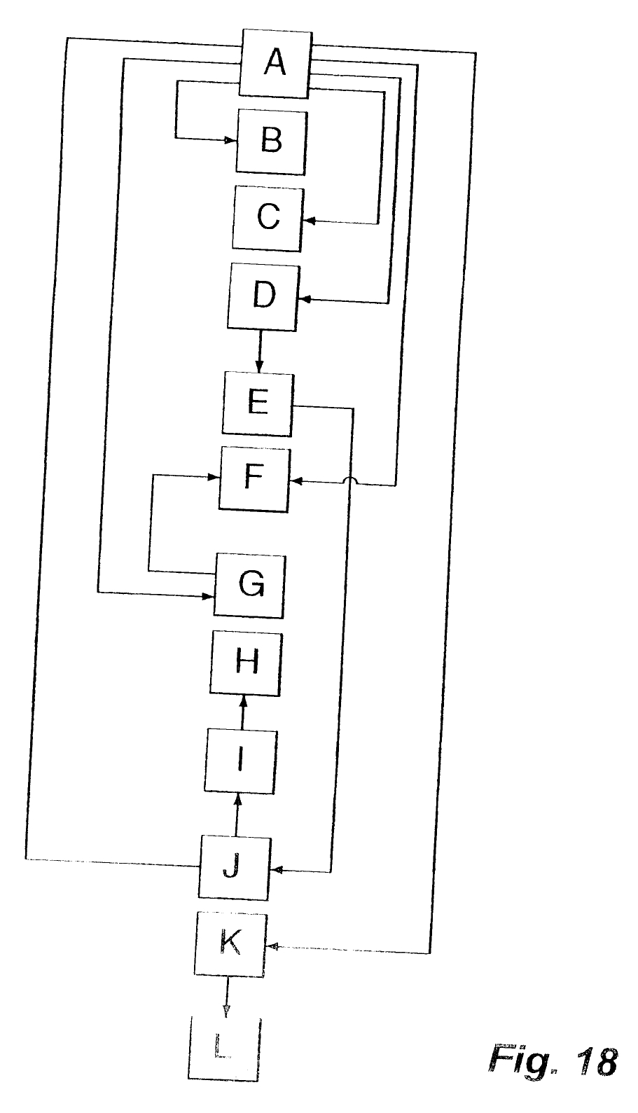

Using a first principles energy model, one can predict the amount of feed volume over a number of seconds that needs to be added to the crystallizer in order to maintain the temperature at the predetermined level. This first principles model compensates for the crystallizer, and specifically for the corresponding dissolver and for the temperature control unit that cools the crystallizer. The model may track valve overshoot and feed heat loss and the concentration of the material within the crystallizer, such as by communication with the actual device inputs and outputs, such as via COM. Thus, the model can be included in a recipe, or recipes, having therein all system components and variables related thereto, and the model can include an amount of time over which to predict, and an output that is the actual feed a volume for the dissolver. Such a model implementation is shown in FIG. 19.

The crystallizer model is simple equations with coefficients. For example, the air in the crystallizer is herein referred to as Delta TE. That air can help assess, for example, how much energy is required for the material and water and, for example, acetone, to raise the temperature one degree. The amount of energy taken away by temperature control unit is herein referred to as QTC. Adding up the QTC can help assess how much energy is needed in order to get the tank to the desired state. That energy is then viewed in light of the actual concentrations in the dissolver tank, and an amount of energy is delivered through a particular volume, as a feed volume, to the actual valve control.

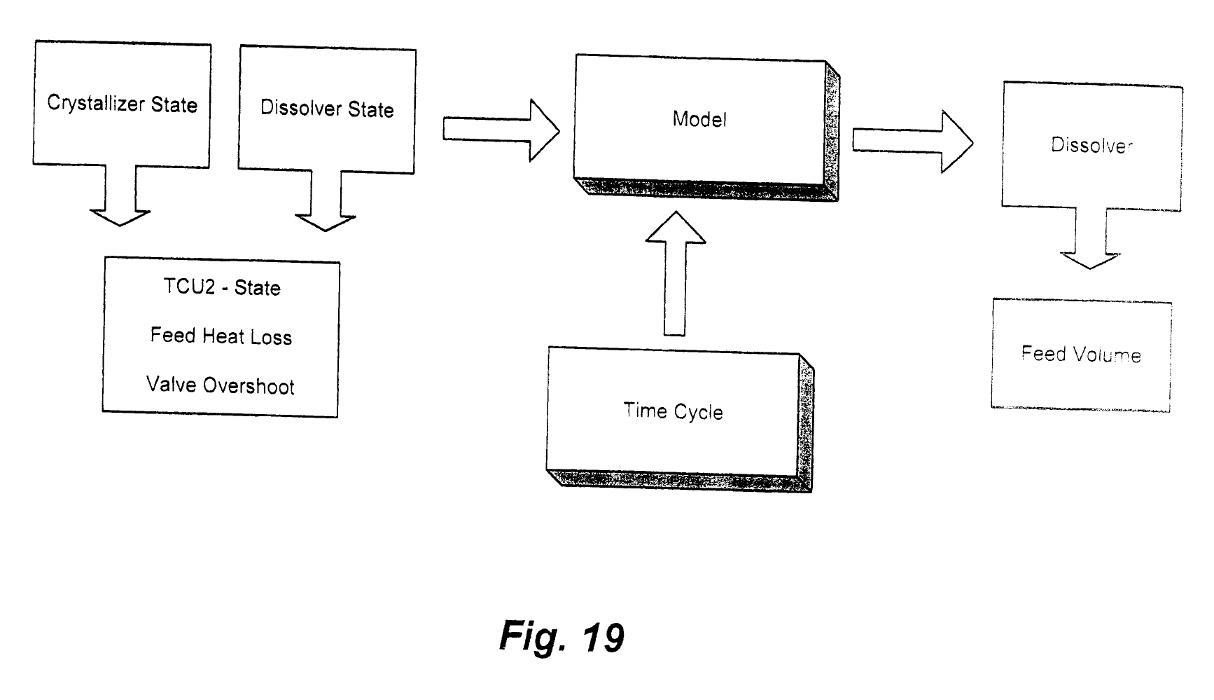

FIG. 20 illustrates an exemplary embodiment of the MBC architecture for a chemical control system, and specifically for the crystallizer application. Agitators 201, hoppers 203, and water jacket controllers 205 are represented by particular components above a Siemens' Profibus Network 207 in this exemplary embodiment. Accessed through OPC is a crystallizer model accessible as a model component, and a sensor from Lasentec is accessed as a Lasentec component. An integrated development environment was used to create this exemplary recipe, and data may be sent through a server, such as an OPC server, to and from this recipe.

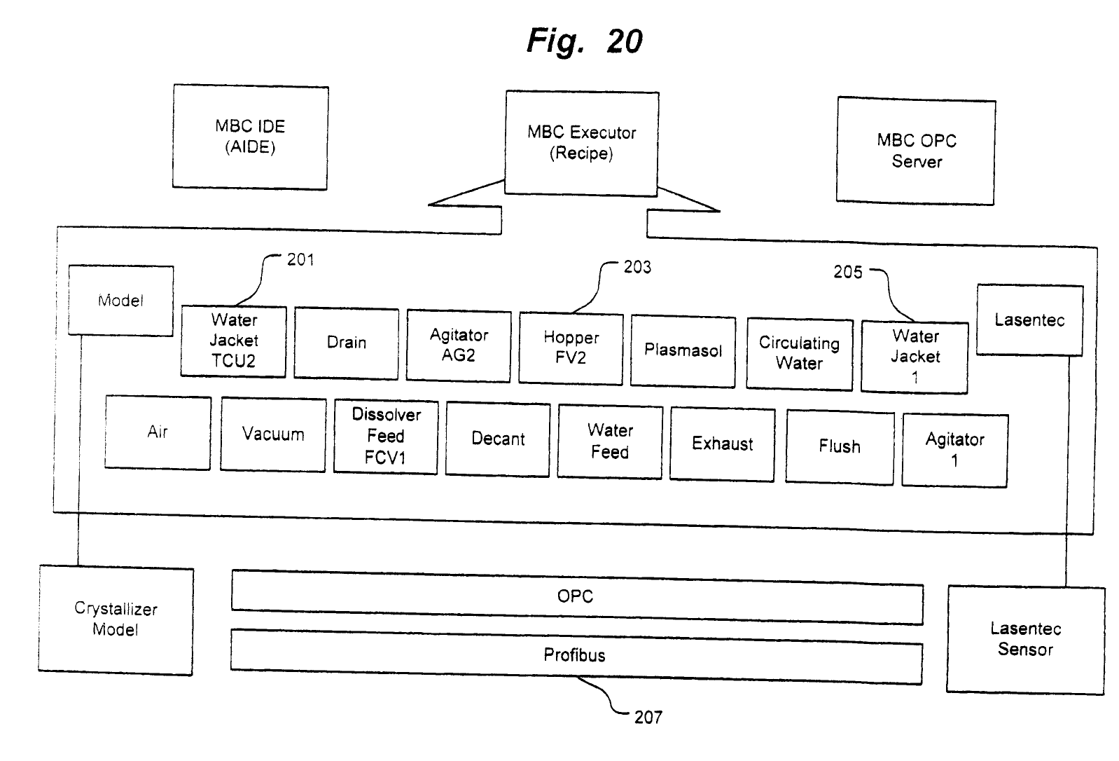

FIG. 21 illustrates a more specific exemplary embodiment of the crystallizer recipe 211 discussed hereinabove. In the first step, at initialization, set up of devices and models may occur, such as the agitators being set to speed. The temperature may then be checked. After checking the temperature and ensuring that the dissolver has reached the appropriate temperature, the position model controller that calculates the material volume for the next cycle is run. Then, the volume is sent out to the valve, and is entered to the recipe as “add volume step”. The recipe then checks to see if these steps are complete, and if two liters has been reached. This check continues until the end condition is met, i.e., the meeting of the two liter condition occurs, and then shut down occurs.

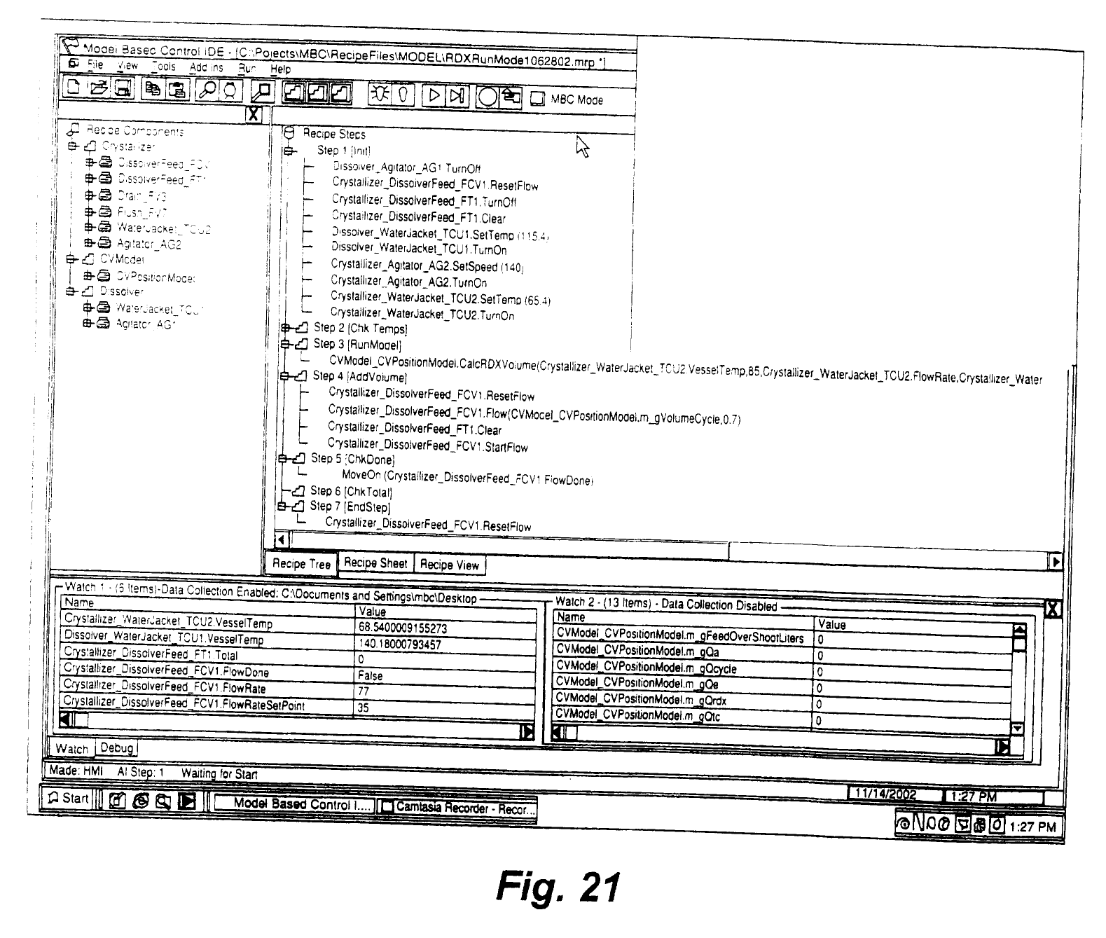

An application of this model in the crystallizer recipe illustrates an improved control of temperature, with a minimum overshoot of 1.2 degrees, and an undershoot of 3/10ths of a degree, as shown in FIG. 22, which was the limit of resolution of the temperature sensors in this illustrative application. This variation is operator independent and entirely repeatable, and could be transferred to another facility that is running another controller.

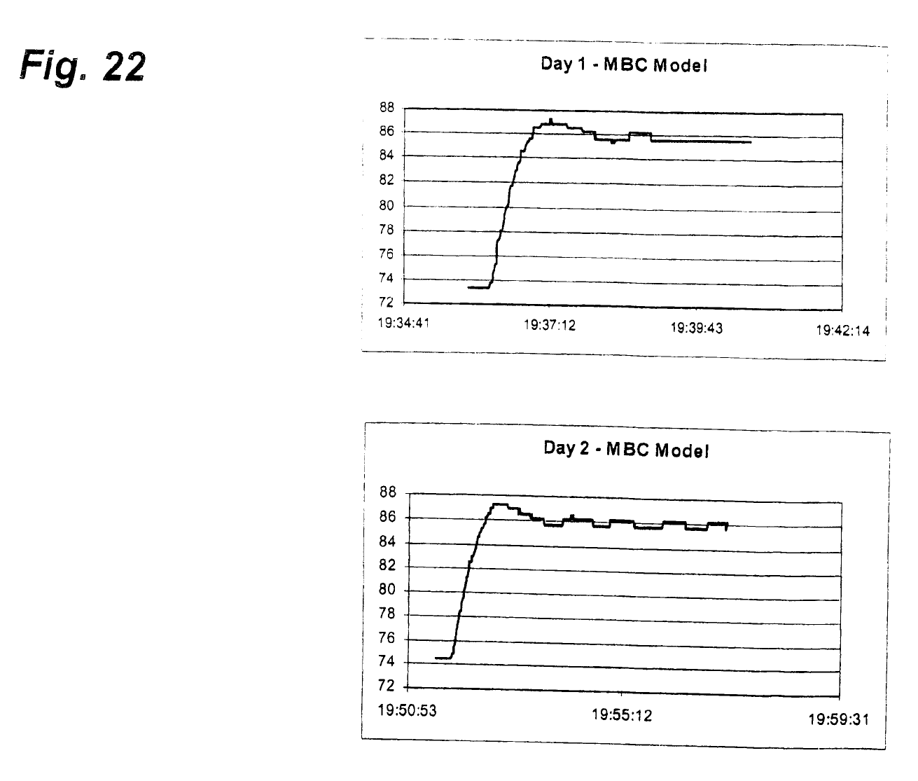

In an additional exemplary MBC architecture illustrative of a mechanical control system application, namely a lathe architecture illustrated in FIG. 23, a recipe created in the integrated development environment generates a run time that looks at the lathe execution control, thermal compensation, part compensation, and data interfaces to an MDSI controller. Step interfaces may be implemented, as well as coordination of models with geometric and thermal models, direct communication with sensors from various vendors, part growth models, and process models, to increase the accuracy and performance of the lathe controlled thereby. The MBC lathe application is additionally an exemplary MBC application for discrete parts manufacturing.

Thus, a recipe may operate heuristically in order to maintain a process at predetermined tolerances. For example, although a given model may include that process occurrence X occurs at motor speed 30 RPM, the model may be alerted by the control that X has occurred at motor speed 22 RPM, and may vary the process accordingly pursuant to an understanding that occurrence X is the goal, rather than the assertion that condition motor speed 30 RPM would accomplish X. Further, those skilled in the art will appreciate that, in accordance with this methodology, steps within a first recipe or first model may be responsive to, or dependent on, steps within a second recipe or second model, wherein the first recipe or model is in communicative connection with the second recipe or model via the MBC coordination environment.

Each model within the recipe may pass information through execution from and/or to an I/O port, or from or to a programmable logic controller. Further, as set forth hereinabove, a plurality of models may be coordinated with a plurality of controllers via the coordination environment. Each I/O port, or each controller, may then be responsible for controlling a particular aspect of a process, such as the crystal growth discussed hereinabove. In prior art embodiments, different models or types of I/O ports, or different types or models of controllers, such as programmable logic controllers, may have been substantially unable to directly interface with one another in order to provide uniform and overall process control across the different models or types. This inability to interface often occurs in the prior art due to the use of different brands, or types, of controllers, which may, for example, employ different interface capabilities or computer programming language capabilities, and this inability to interface is remedied, in part, through the use of the present invention.

Thus, the coordination environment of the present invention allows for multiple controllers, each of which may operate in accordance with a different operating environment, which different operating environments may be remote from the coordination environment 12 and/or the model environment, and which multiple controllers may operate in unison in accordance with at least one model 13 or recipe communicating through the coordination environment 12. Additionally, the present invention allows for the replacement of equipment, or controllers, within the controller environment communicating through the coordination environment 12. For example, two models programmed with the tolerances, and technical aspects, of each of the old and the new equipment, respectively, may be adjusted accordingly for the incorporation of the new equipment without substantial variation to the recipe. This switching between models within the recipe may be engaged, for example, by the process engineer, upon installation of new equipment, without any substantial reprogramming by the process engineer. Thus, the process engineer need not change the nuances of the model or models run within the recipe, but rather need only change the equipment or controllers available in the controller environment communicating through the coordination environment, and need only instruct the coordination environment 12 as to the presence of that particular equipment or controller in communication with the coordination environment 12.

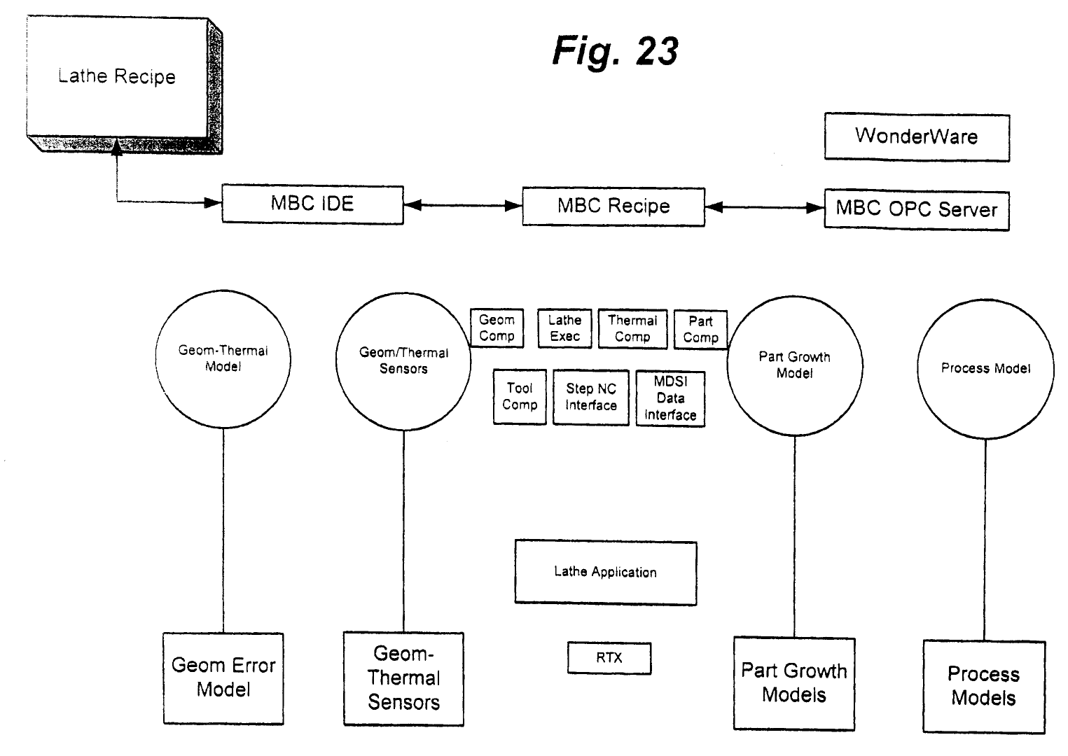

Returning now to FIG. 2, the executor 14 may include, for example, the ability to monitor the running of a recipe in run-time, and/or to interactively monitor component property values during execution, and/or the ability to monitor and/or collect data during run-time. For example, FIG. 24 is a screen shot within the executor 14 illustrating a viewer for viewing the run-time of a recipe. In the exemplary embodiment illustrated, material viewable from within the recipe run-time viewer may be included, and/or presented, within a COM library, such as a library denoted “recipe interface”. The run-time viewer may be a stand alone application, for example, or may additionally be integrated with, or within, the IDE 21.

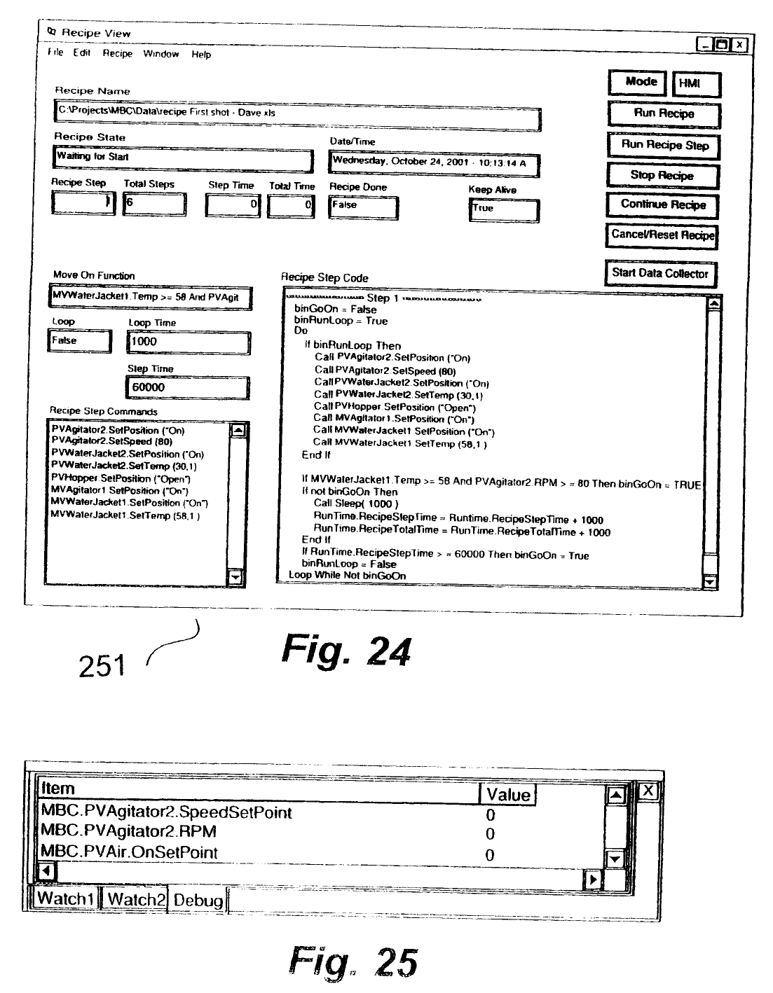

In this exemplary embodiment of an execution environment, the viewing of run-time component property values may be enabled through the use of a watch window, such as that illustrated in the screen shot of FIG. 25. The watch window 251 may be, for example, a dockable or floating window that enables a user to monitor component property values, such as during run-time or debugging. The watch window may additionally include a plurality of tabbed views, wherein varied watch configurations may be made available by clicking on selected ones of the tabs. As used herein, one skilled in the art will appreciate that tabs may include, for example, selectable drop-down menus, point and click menus, hyperlink menus, and the like.

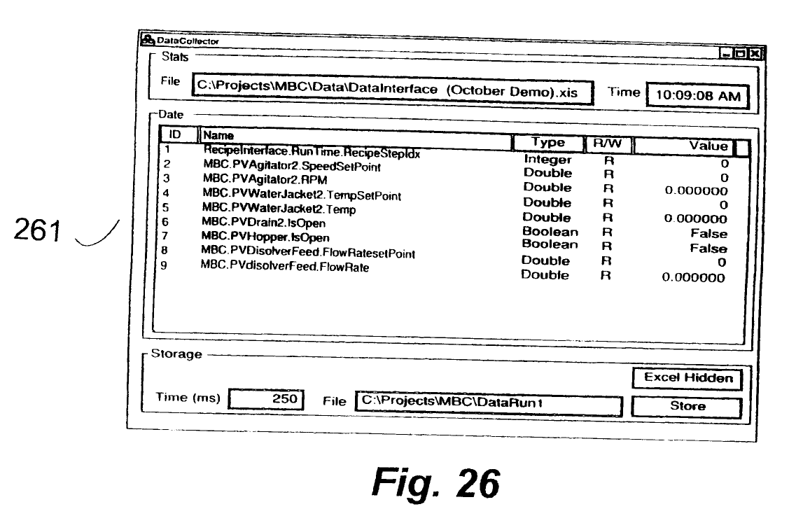

Additionally, in this exemplary embodiment, a data collection window 261 may be included in the execution environment, such as that illustrated in the screen shot of FIG. 26. The data collection window may be a dockable or floating window that enables the monitoring and/or storing of component property values during recipe execution. The data collection window may include, for example, tabbed views similar to those discussed hereinabove with respect to the watch window. The data collection window may, for example, collect data and allow for display of that data to a user at a predetermined minimum rate commensurate with the change rate of the data of interest, such as, for example, at least once every two seconds. Data collection capabilities accessible via a data collection window during run-time may include, for example, file compression, storage to at least one file type, such as, for example, to a spreadsheet or .CSV file, and the data collection window may include a configurable storage directory.

Further, preferably within the watch window, the data collection window, or a storable file, applicable programming code for the recipe run may be made available and/or recordable, such as for review of the recipe run by an MBC user. For example, a run file may be created for the running of a particular recipe, which run file may be saved, for example, to the desktop. This methodology of file saving may allow, in an exemplary process, tracking of the time of occurrences in the running recipe at the shortest time frame provided by the computer operating system on which the run code is generated.

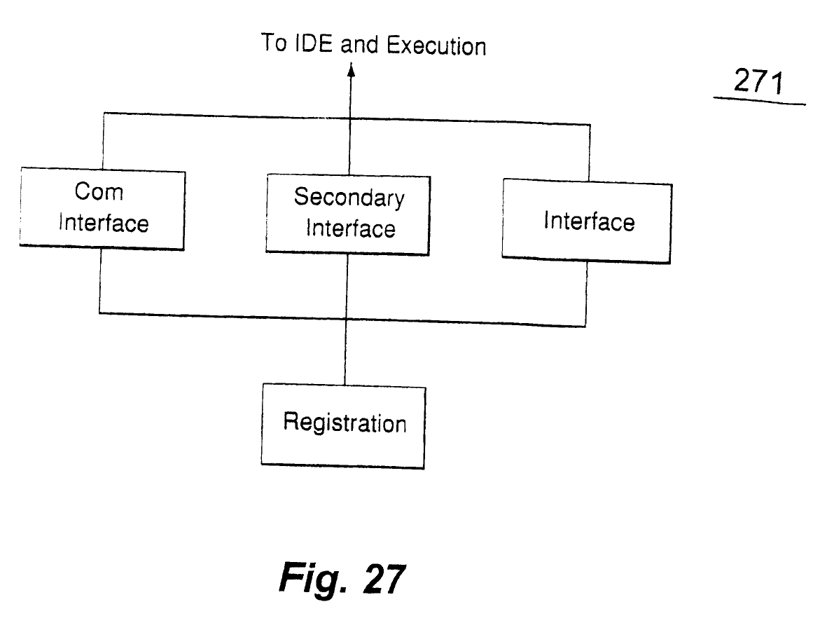

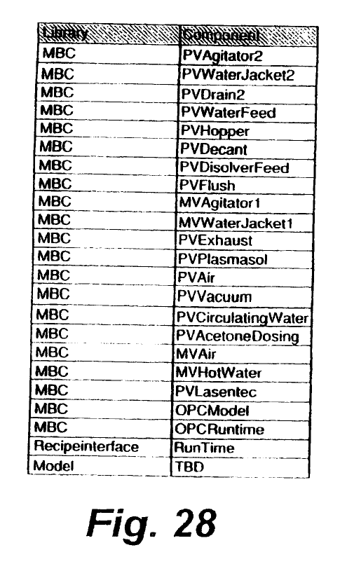

Each of the development environment and the executor preferably allows for the configuration and/or monitoring of the components, and/or libraries of the components, employed in the recipes of the present invention. FIG. 27 is a block diagram illustrating an MBC component 271. An MBC component, as discussed herein, includes software or hardware items that provide, or allow connection to, an open interface, such as COM or XML Services, and that self-register, or that can be registered, with, for example, a Windows operating system environment, such that the IDE can locate the component during recipe development, and such that the executor can locate the component during execution. Further, the components of the present invention preferably implement at least one component interface. FIG. 28 is a chart illustrating a list of exemplary components, which may be available, for example, via the MBC component library, as discussed herein.

Open interface, such as COM or XML Service, as used herein, allows applications and systems to be built from components supplied by different hardware and/or software vendors. COM or XML Services may be an architecture employed to form foundations for higher level software services. Higher level software services may span varied aspects of component software, such as compound documentation, custom control, inner application scripting, data transfer, and the like. COM or XML Services is an architecture that defines a binary standard for component interoperability, is programming language independent, may be provided on multiple platforms, provides a robust environment for evolution of component based application and systems, and is extensible, as will be apparent to those skilled in the art. In addition, COM and XML Services may allow for communication between components, such as across process or network boundaries, shared memory management as between a plurality of components, error and status reporting for components, and the dynamic loading of components.

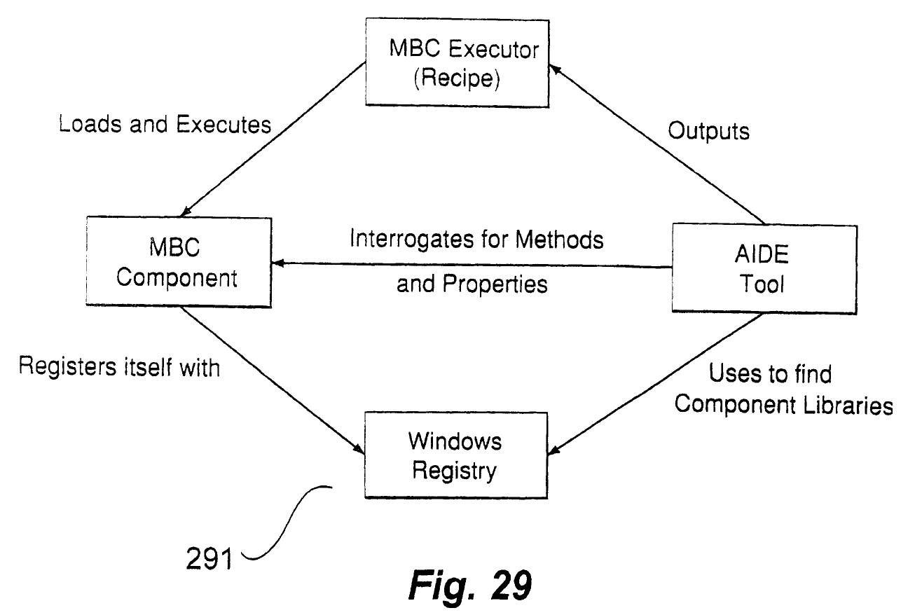

Returning now to FIG. 27, an MBC component is a building block within the MBC system. An MBC component is present within the IDE in order to allow for the creation of recipes, for example, and an MBC component is executed within the recipe upon execution in the executor, as discussed hereinabove. An MBC component may exist, for example, as a COM object within a COM library, or as a stand alone XML Service, as set forth hereinabove. A component library may be, for example, a collection of classes that have implemented at least one open interface. It will be apparent to those skilled in the art that an MBC component may be implemented by an interface, such as by a secondary class interface separate from a first component interface, which secondary interface may allow the IDE 21, and/or a component configuration utility within, or in association with the IDE 21, to properly address MBC components in a uniform fashion. For example, FIG. 29 is a block diagram illustrating the addressing relationship between an MBC component and other MBC system elements.

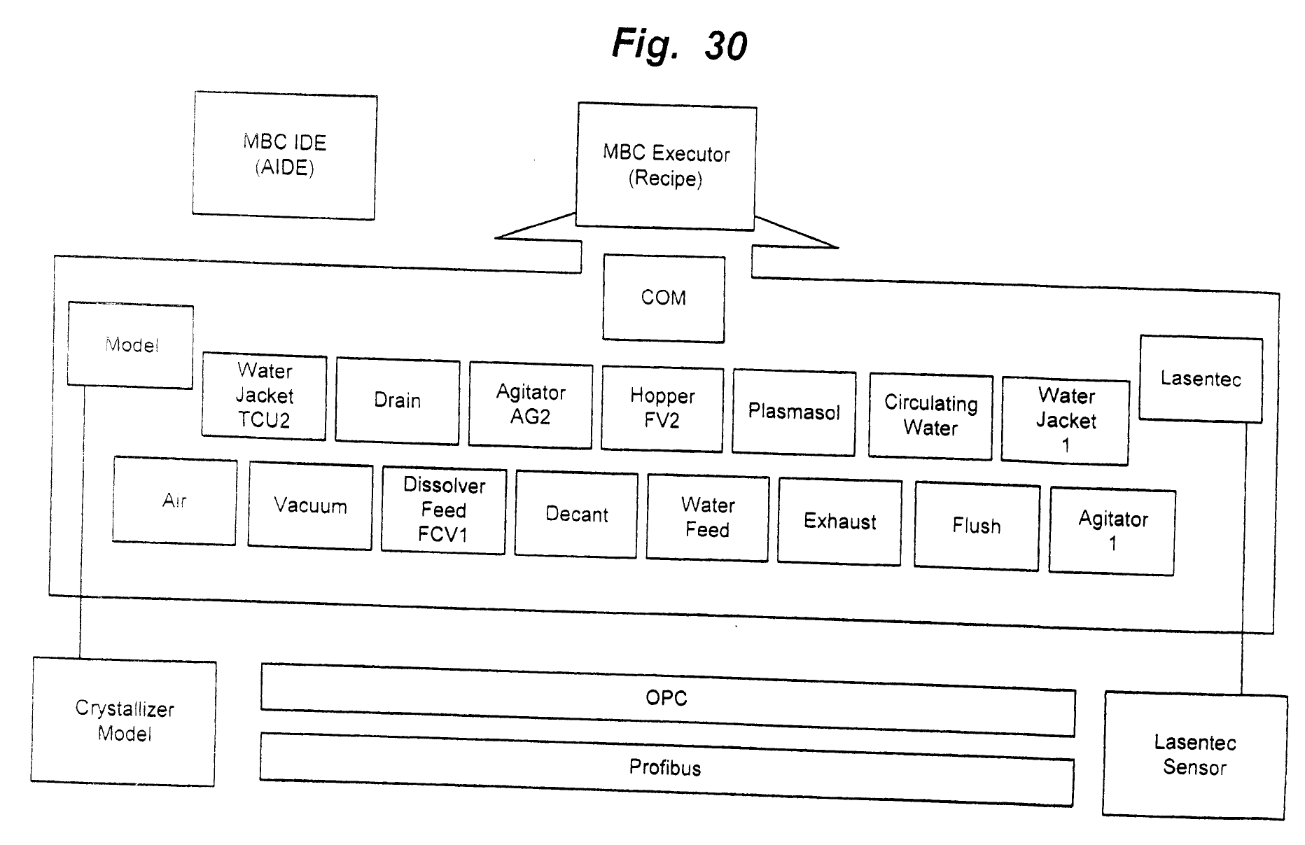

With reference to FIG. 29, a component is herein defined as a collection of function calls to a library, as illustrated in FIG. 30. Therefore, a model based controller component is a library that represents an interface to, for example, a device having functions such as turn on, turn off, set speed, and/or an interface to a model that might initialize the model, set the volume for the calculation, or calculate a valve position based on that model, for example. Thus, a component is merely a plurality of function calls together in a library, and a model based control component is a component as applied to a controls problem.

Returning now to FIG. 29, an MBC component may register, or be registered, with the operating system registry, such as a Windows registry, such as through the use of a registration wizard 291, or component wizard, which registration wizard may respond either automatically within the MBC, or to a user request for component registration. For example, upon implementation of the IDE 21 or executor 14, a search may be performed for components in the operating system registry, and that search may allow for the building of at least one MBC component library of registered components. The component list may then be made available to the recipe developer within both the IDE 21 and the execution configurations. Upon selection of a set of component libraries, the MBC components may be interrogated, via, for example, the COM or XML Service interfaces respectively, to assess the method, properties, and configuration of each MBC component. Within the IDE 21, the MBC components may be presented as a selectable list of available libraries, such as for different tasks, recipes, or model types, wherein each library may contain the methods, properties, and configurations then used to create recipes.

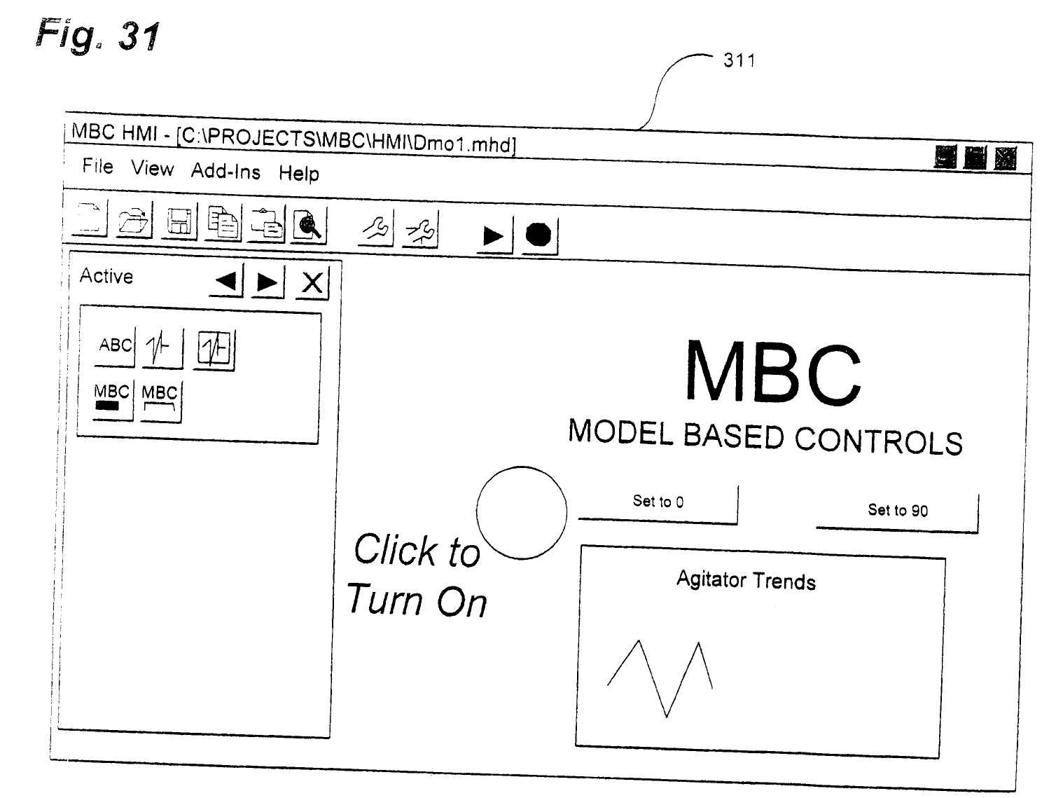

A Human Machine Interface 311, as illustrated in FIG. 31, allows for graphic viewing of the components, and may encompass the graphical interfaces discussed hereinthroughout. The HMI allows the creation of, and may provide templates for, charts, buttons, hot keys, or the like, that may be used to set individual functions within a particular component. All components may preferably be accessible via the HMI.

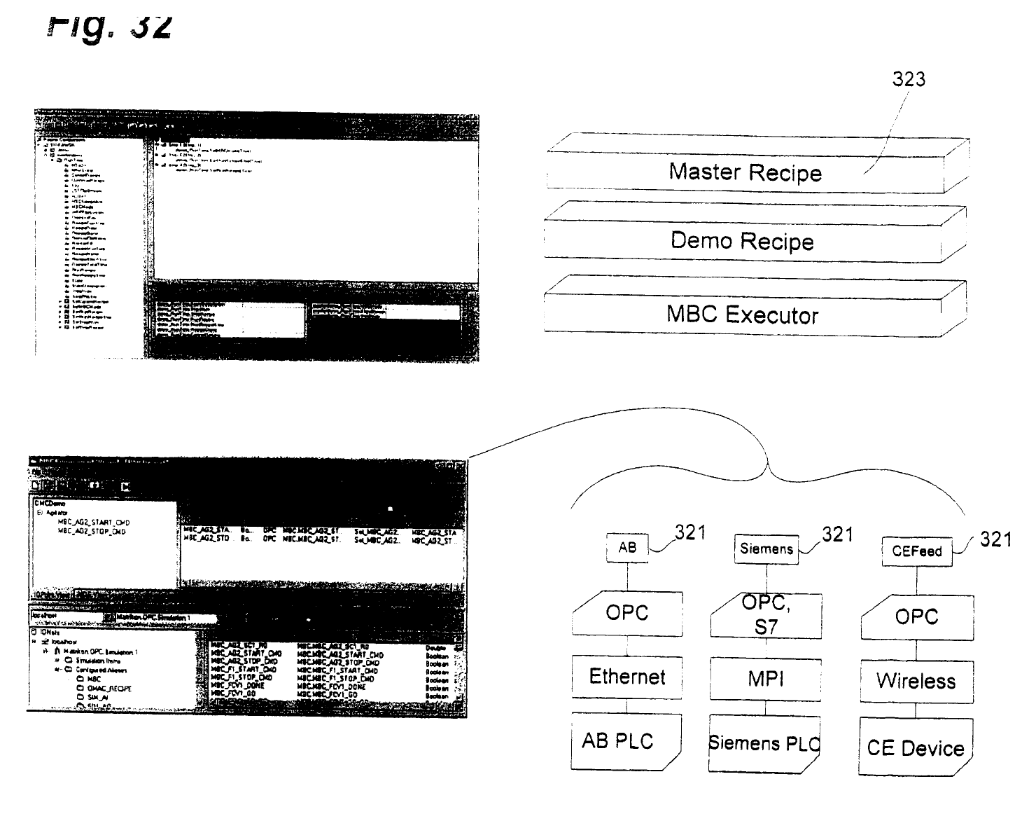

FIG. 32 illustrates a virtualization tool for virtualizing components using an HMI, i.e. a registration wizard, for component registration with the MBC. FIG. 32 illustrates actual control hardware 321, such as an Allen Bradley PLC or a Siemens' PLC or Windows CE device, residing below an open interface 323. The component wizard may interrogate these individual systems and create components as illustrated in FIG. 31. Once those components exist, they can be applied to the MBC integrated development environment, which may use the components to create recipes. The executor may then execute these various recipes. Thus, the component wizard and an advanced integrated development environment may be used together to create components, recipes that employ those components, and execution of those recipes.

Thus, a component wizard may support a distributed MBC, and provide user options, configuration management, and templates to create a series of components that emulate and control a particular device. Common MBC interfaces and support, including cut and paste, drag and drop, and support of external application developments, including generating validation in unit display interfaces, ability to connect to remote servers, and distributed support in the components, is preferably provided within the registration wizard.

In addition, it will be apparent to those skilled in the art that new communication elements or types, unknown by the registration wizard, may be programmed into the registration wizard. For example, in an embodiment wherein a particular device communicates serially, such as directly with a PC, the registration wizard may be programmed to read a computer serial port in order to receive data from, and thereby allow for registration of, that serial device. This addition of new device types may include a hard coding of new device types, a file download of new device types, or a creation of new objects within an object-oriented environment for new device types, for example. It will be further apparent that, in an embodiment wherein, for example, a programmable logic controller (PLC) is capable of direct communication with the new device, such as the new serial device, and wherein the PLC is already registered as a component, the new device need not be registered as a component, but rather may be controlled by the MBC by exertion of control over the PLC to which the new device is communicatively connected.

Registration of a new device as a component, such as an Allen-Bradley controller containing the device logic for a production vessel, or such as an agitator and/or a flow valve that may feed materials, both of which may, for example, be controlled by a motor through a control network in the PLC, may include accessing of “tag points” within, or/on, or associated with, each device, controller, or PLC to be registered. The accessible tag points may vary by device type, such as true I/O ports, or PLC device logic as described through either ladder diagrams or sequential function charts, for example. The MBC may be applied to create virtualized components that represent the individual devices, and that act on the actual devices by accessing the “tag points”.

For example, the MBC, upon instruction to connect to a device, such as a PLC, may seek out “tag points” that are the I/Os of the PLC, or that are connection points to the PLC. This seeking of tag points may include, for example, a querying of available I/O to assess connection of the PLC to the MBC, and/or a dump of the software of the PLC to the MBC and review of the dumped software by the MBC for predetermined keys that are generally indicative of tag points, such as external I/O points, for that particular type of PLC.

In a specific example, an agitator component may be created that has methods such as turn on, turn off and set speed, and that then interfaces to the Allen-Bradley PLC and its external I/O through “tag points.” There may, alternatively or additionally, be valves, dissolver feeds, and/or water jackets. These components are created in an interface specification for the MBC such that the known behavior of the actual hardware is presented to the MBC via the tag points.

A process engineer, through the MBC integrated development environment, is able to exercise these components and the methods thereof upon registration of the virtualized components. A recipe, herein defined as a series of steps that describe the methods or functions within each component called, and the calling sequence thereof, which might say not to move on from a particular recipe step until the agitator gets to a certain speed, and including a series of such steps with looping and branching decision logic that emulates a controller, may be created. Once the process logic of the virtual components is created to access the actual device logic of, for example, the Allen Bradley PLC, the process logic can be maintained, and components can be configured to look at the Allen Bradley controller's tagged points in accordance with the configuration file that each component loads. This allows portability of the process logic independent of the actual vendor or the actual device, because under the component and the component interface is created a uniform, universal specification that ensures the portability of the process logic.

In an exemplary embodiment of registration, selectable components may include hardware components, such as programmable logic controllers (PLCs), in certain embodiments of the present invention. These components that are controllable and registerable with the MBC 10 may be automatically added to a list of eligible components upon communicative connection to the MBC, or upon a search for eligible components as described hereinabove, such as by an automated sensing of the communicative connection, such as by a reading of the tag points from a PLC upon the automated sensing, wherein the tags include information pertaining to communication protocols for the PLC. Upon the reading of tags and initiation of a COM object, the PLC may be registered and made available for recipe projects. The ability to automatically communicate with numerous controllers of different makes, models, or communication types provides interoperability across controller platforms in the present invention. Further, it will be apparent to one skilled in the art that this methodology may be extended, for example, to different kinds of hardware, such as sensors, valves, actuators, motors, and the like, inter-communicating with each other and one or multiple controllers, via the use of the component registration of the present invention.

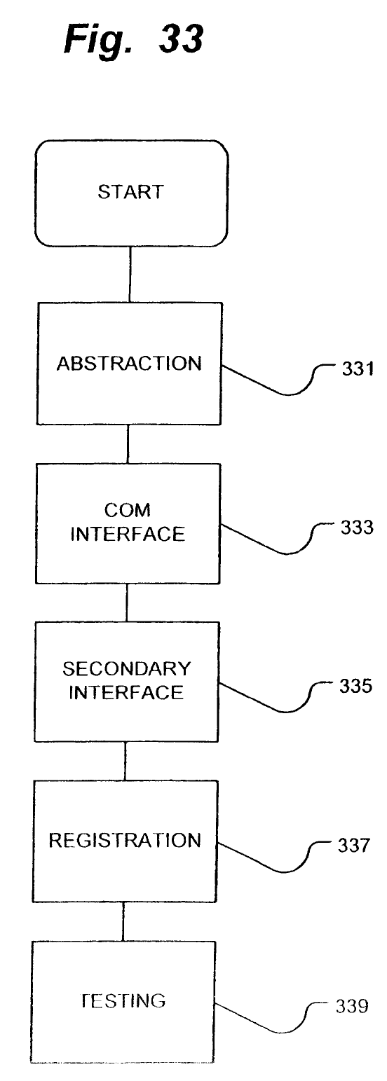

An MBC component may be formed and formatted using, for example, visual basic. FIG. 33 is a flow diagram illustrating the development of an MBC component, wherein the steps of the development may include creation of an abstraction for the component 331, the creation of a COM or XML Service interface for the component 333, the implementation of the secondary interface for the component 335, the registration of the component with the operating system 337, and the integration and testing of the component 339.

Additionally, for example, the MBC may be formed and formatted using Web Services technology, such as an MBC.NET environment, which allows a developer to browse, develop, and execute recipes and components from any web-enabled computer. This increases the number of environments that may be leveraged via the MBC. Further, this allows for, in addition to the runtime environments discussed hereinthroughout, the MBC to employ alternative runtime platforms, such as Windows XP Embedded, Windows XP Real Time, and Windows CE.NET, for example.

The first step of the development of the MBC component may be the development of an abstraction component, or as discussed hereinabove. Upon completion of the development of the abstraction, a COM or XML Service interface may be created for the component. A COM or XML Service interface may be created in, for example, visual basic as, for example, an ACTIVEX DLL or EXE file. Project settings may determine the name of the component library, and the classes of the library may determine the components allowable therein. Thus, using visual basic, in order to create an MBC component and library, an ACTIVEX DLL or EXE file may be created for the project, and one or more classes may be added to the project. The name of each class may determine the name of the component, as will be apparent to those skilled in the art. Subsequently, methods and properties may be added to each class in order to implement the abstraction of the component developed hereinabove. References may be added for the MBC library and type libraries, and a DLL or EXE may be built.

The implementation of the secondary interface discussed hereinabove allows the MBC system applications, including the IDE 21 and the component configuration utility, to treat MBC components in a uniform way, as set forth hereinabove. The secondary interface methodologies and properties may not be visible from within recipes, such as during recipe development.

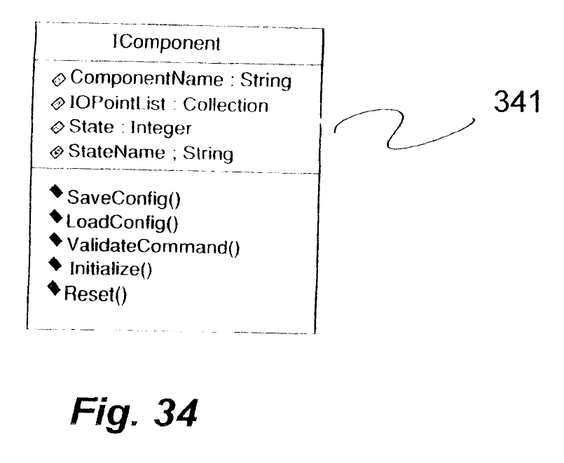

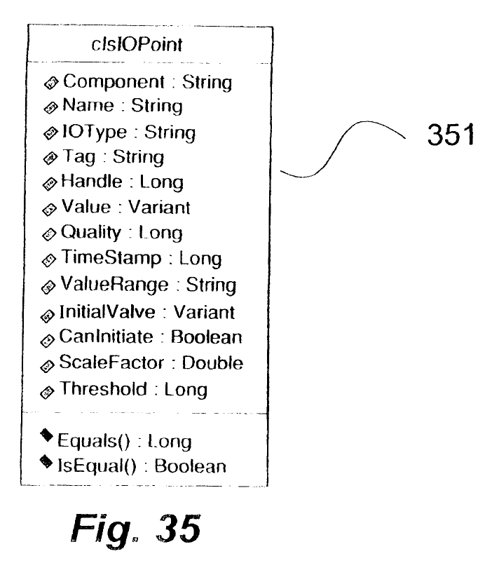

A UML diagram for an exemplary secondary interface 341 is illustrated in FIG. 34. With respect to FIG. 34, a variable component name is a fully qualified name for the component, and includes the library of the component. The “I/O point list” may be a collection of I/O point objects, for example. “State” may be an integer value that represents the internal state of the MBC component. “State name” may be the string representation of the state of a given variable. “Save configuration” may be used to save a component's configuration, which may include the name of the component and the I/O point list of the component. “Load config” may be used to load a component's configuration. “Validate command” may be used to check the set point for an I/O point value against the I/O point valid range of values. “Initialize” may be used to initialize the component. “Reset” may be used to reset the component. An exemplary hardware point object list 351 for an MBC component is illustrated in FIG. 35.

Additionally, the MBC component and component library may be registered with the operating system, as set forth hereinabove. This may be done, as will be apparent to those skilled in the art, via a variety of methods, including the creation of a key for registration. The registration key for, for example, the IDE tool, may include the values for persisting the state of the IDE tool, such as user preference values, window size and location values, and file list values. Each component may create its own key value for registration. Upon a registration, or an attempted registration, the component and library may be tested.

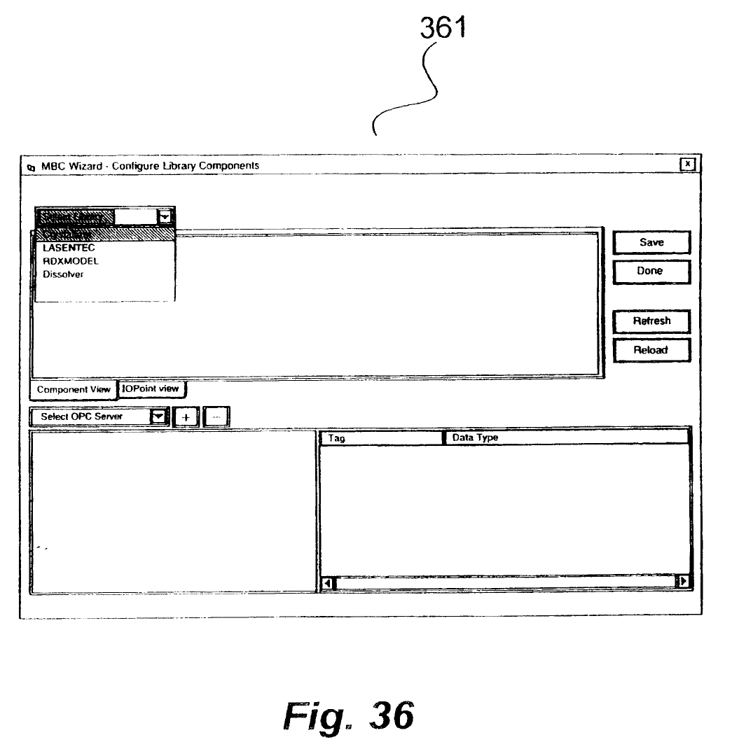

The component library may be tested, for example, by testing that the component is a valid COM or XML Service object, has implemented the secondary interface, has a correctly implemented an abstraction, and operates correctly with the IDE. The component library may be tested using the MBC configuration utility. Further, in order to test the components and component library, the library registration may be checked. FIG. 36 is a screen shot illustrating the testing of library registration 361. Wherein a component library is correctly registered with the MBC system, the component library or libraries may be displayed within the MBC component configuration.

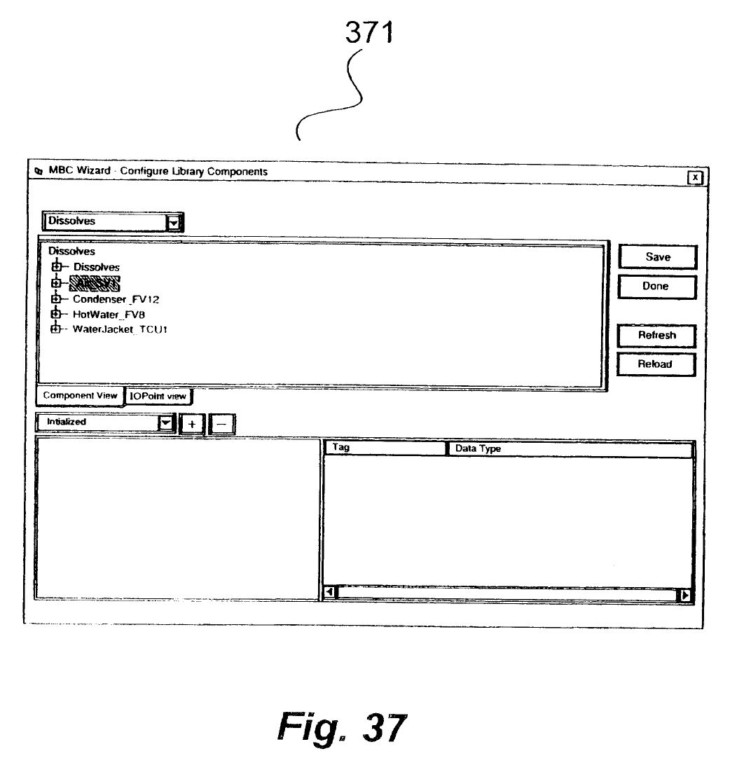

In order to test that a component is a valid COM or XML Service object, a library 371 may be selected that contains a component in question from the library list, as illustrated in the screen shot of FIG. 37. Valid COM or XML Service objects may be displayed within the library, such as within the tree view of the library, as illustrated.

In order to test for the secondary component implementation, each object in a component library may be associated with a flag, wherein the flag is set to provide recognition that the secondary interface has, or has not, been implemented. In an embodiment wherein the secondary interface has not been implemented for the selected component or component library, a warning message may appear.

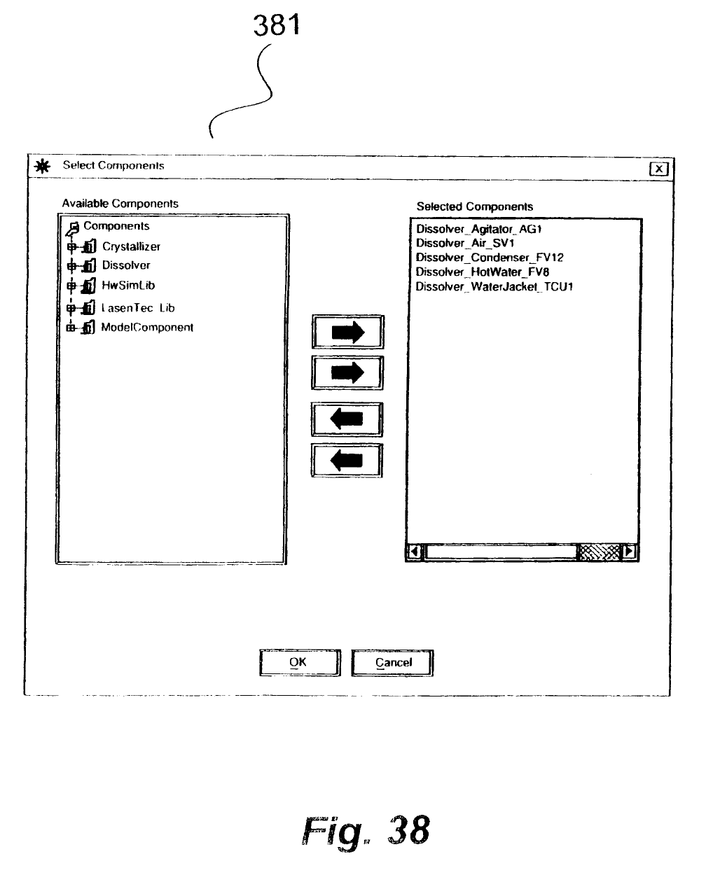

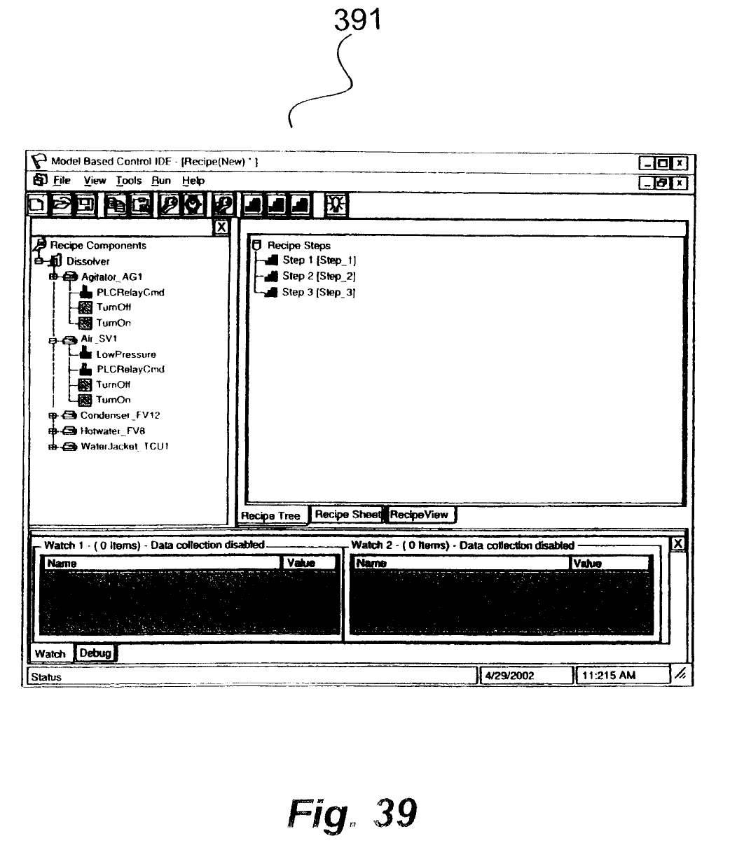

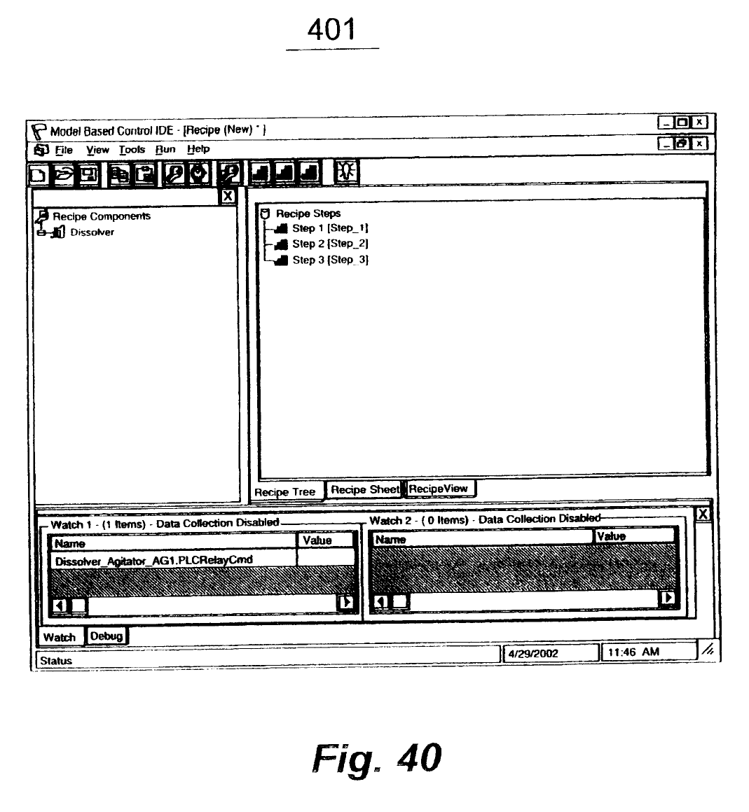

In order to test the component abstraction implementation, a subjective evaluation may be made, wherein the subjective evaluation may, for example, test the component within the IDE against, for example, a simulation, and may test the component again in, for example, the run-time environment. In order to test the component abstraction implementation in the IDE, the IDE may be started and a component library may be selected for checking of the component library methods and properties within IDE, as illustrated in the screen shot 381 of FIG. 38. The abstracted components may then be tested in a recipe 391, such as that illustrated in FIG. 39. In order to assess the correct function of a component from within the executor, for example, a property of the component may be added to, for example, the watch window, as discussed hereinabove. If a component has been properly and successfully created, the property 401 may display in the watch window as illustrated in FIG. 40. If the component was improperly created or constructed, an error message may appear.

In operation, the MBC system may include a developed recipe. The recipe may be developed by entering the IDE, and opening an existing recipe project, or by creating a new one. The recipe may be developed by the addition of components, the creation of recipe steps and/or recipe models, the addition of components to the recipe or model steps, and the collection of set-up data. The recipe may then be debugged, such as through the use of watch windows, the display of recipe break points, a review of captured data from recipe execution, or by troubleshooting the logic of the recipe. Following debug, a recipe may be saved, and/or deployed. The components for the recipe used may be developed using, for example, Visual Basic, Visual C++, Java, C# or Delphi, and the components developed are preferably registered with the operating system or MBC environment prior to use within a recipe as discussed hereinthroughout.

Upon validation of the recipe, a process may be controlled, such as via a combination of a controller and a model. The recipe thus includes the coordination between the controller and the model. The process may be dynamically controlled, or predictively controlled. With dynamic control, the recipe may set model input properties based upon process input data. The recipe may further call a model in order to calculate outputs based upon the model input properties, and may then update the model in accordance with output properties. The model outputs may then be used by the recipe to control the process. For predictive control, the recipe may initialize start-up parameters, and may call a model to produce predictive data for the running of the process. The recipe may then capture the model predictive data in, for example, a memory, such as a table. The recipe may then make calculations using the model predictive data, and may control the process in accordance with these calculations. A predictive model may be employed, for example, in a neural net application such as that discussed hereinbelow.

Thus, as set forth hereinabove, in order for the recipe to exercise predictive or dynamic control of a process, the recipe may be executed by the executor, such as by a recipe execution engine. Recipe execution may include the execution of the series or plurality of recipe steps, such as in the form of models as discussed hereinabove, which recipe steps may include, for example, component methods, pre and/or post processing logic, branching or got logic, move on conditions, loop indicators, loop times, and/or step times. The component methods may include at least one method call in accordance with a hardware component set point, in order to allow for control of that hardware component within predetermined tolerance levels. Preprocessing logic may be executed at the beginning of a recipe step. Post-processing logic may be executed at the completion of a recipe step. Preprocess and Post processing logic may redirect the recipe execution to a goto, or to branch to another recipe step. For example, preprocessing logic may compare a temperature reading and determine that a emergency flush of a container is appropriate. The preprocessing algorithm might, in this exemplary embodiment, call a Goto function with the name of the recipe step that executes the emergency flush. Preprocessing or postprocessing logic may also branch to a series of steps and return to the original step upon reaching a return recipe step, for example. Move on conditions may, for example, include Boolean expressions that are evaluated in order to determine whether the recipe can move to a subsequent recipe step. For example, an expression may be developed that will allow for the running of a particular model until a predetermined condition is met, and, upon the meeting of that condition, another recipe step, or a different model, may be allowed to run. In an exemplary embodiment employing control of a motor, the recipe may not be allowed to move to a next step until the controller tells the model that the motor has reached a speed preset within the move on step, such as a certain number of RPM. Loop indicator may include a Boolean expression that determines whether the recipe can execute the component methods in a loop. Loop time may determine the execution frequency of a recipe step loop, and step time may determine the maximum duration of a recipe step.

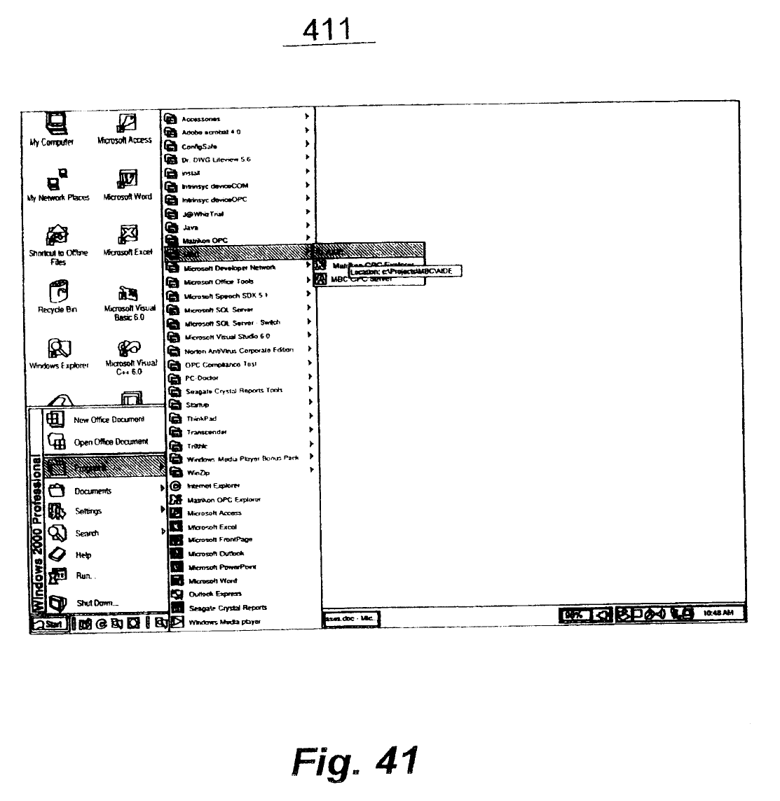

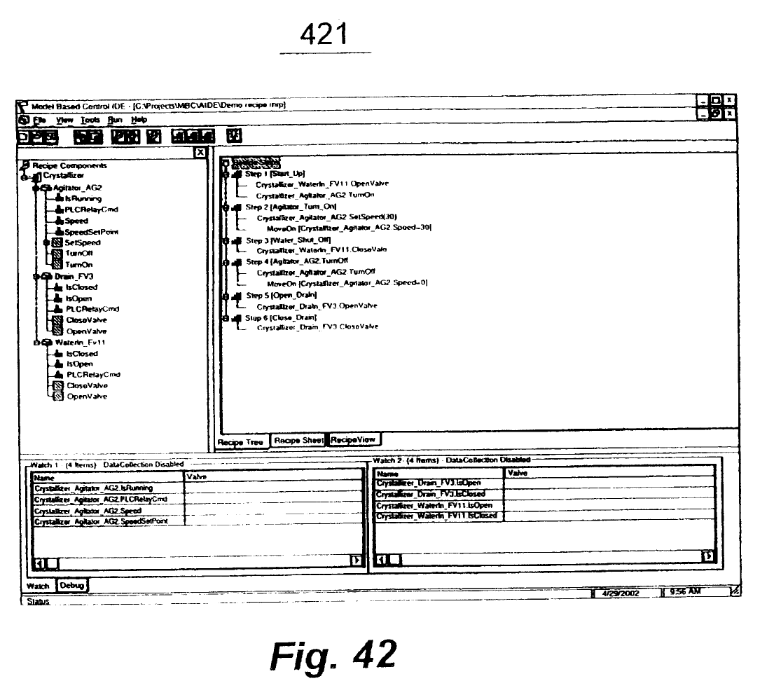

Also, as set forth hereinabove, in order for a recipe to be executed in the execution environment, the recipe may be developed in the development environment, such as in the IDE. FIG. 41 is a screen shot illustrating the opening of an IDE application 411. The IDE application may include a plurality, such as six, IDE components. The IDE components may include, for example, a recipe editor that creates, debugs, and/or prepares recipes to run, an MBC component browser to facilitate recipe creation, a watch window that allows for the viewing of recipe progress during debug, and a framework for inter-process communication and recipe development. An exemplary IDE layout 421 is illustrated in the screen shot of FIG. 42. FIG. 42 illustrates a split layout, thereby providing increased user convenience. The exemplary split layout illustrated employs a tree layout of recipe components on the left-hand side of the screen, wherein the components displayed are components of the recipe step selected on the right hand side of the screen. The right hand side of the screen provides a tree layout of the recipe, including each of the plurality of models, or recipe steps. Information is given as to each of the plurality of recipe steps, such as move on function to allow for selection of a proper move on point during execution, and a loop, loop time, and step time function for the selected recipe step. The IDE layout illustrated in FIG. 42 includes at least one watch window, wherein the watch window provides additional information regarding the recipe displayed.

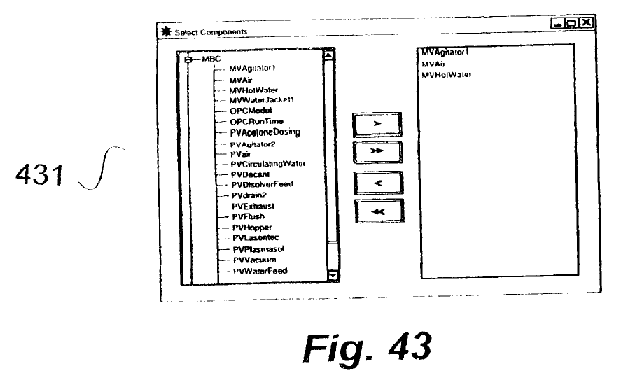

In this exemplary operational embodiment, a new recipe may be created, such as by selection of a new recipe project from a selectable menu within the IDE. The user may be allowed to interactively select components for placement into the new recipe project. The selection of components may be allowable by a screen shot similar to that of FIG. 43. Available components 431, such as those illustrated in FIG. 43, may be viewed by expanding component categories, such as through the use of a treed menu. Components may then be selected or removed, such as through the use of single arrow buttons, double click, or the like. All components may be selected, or removed, simultaneously, or by category, for example, such as through the use of a selectable icon, or a double arrow button, for example.

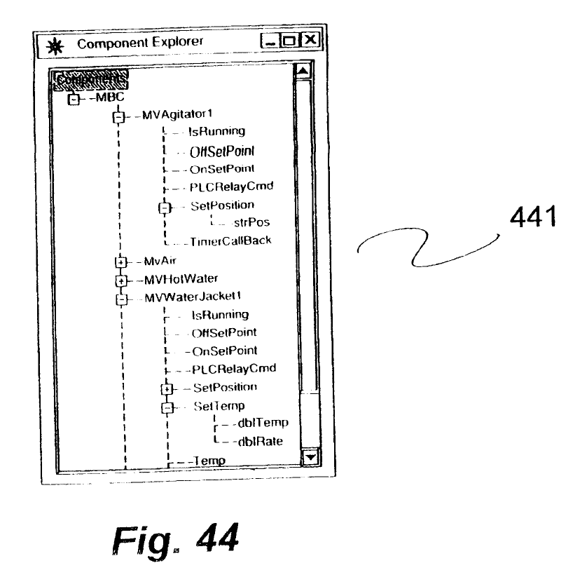

Upon selection of components, selected components may be explored within the IDE, such as through the use of a component explorer window 441 as illustrated in FIG. 44. As illustrated, the component explorer allows for the viewing of properties and methods of each component selected for a recipe project, and these properties and methods may be expandable, such as through the use of a treed menu. Components may additionally be added, or information as to components may be viewed, through selection of components within the component explorer window, for example.

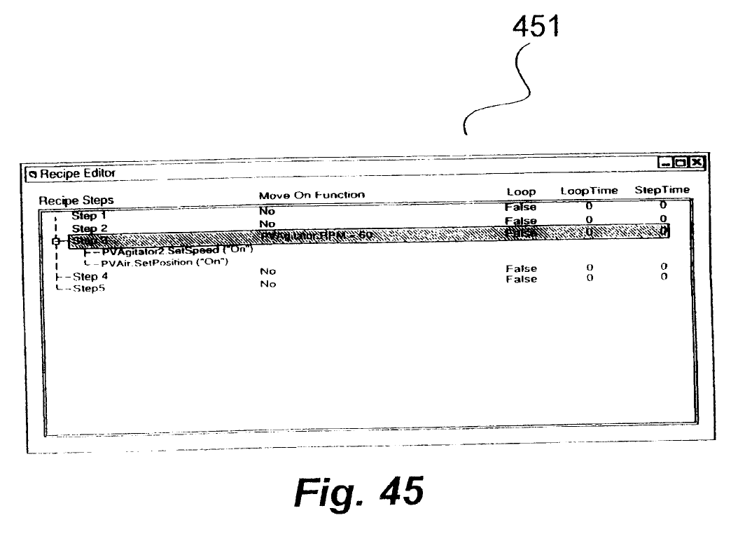

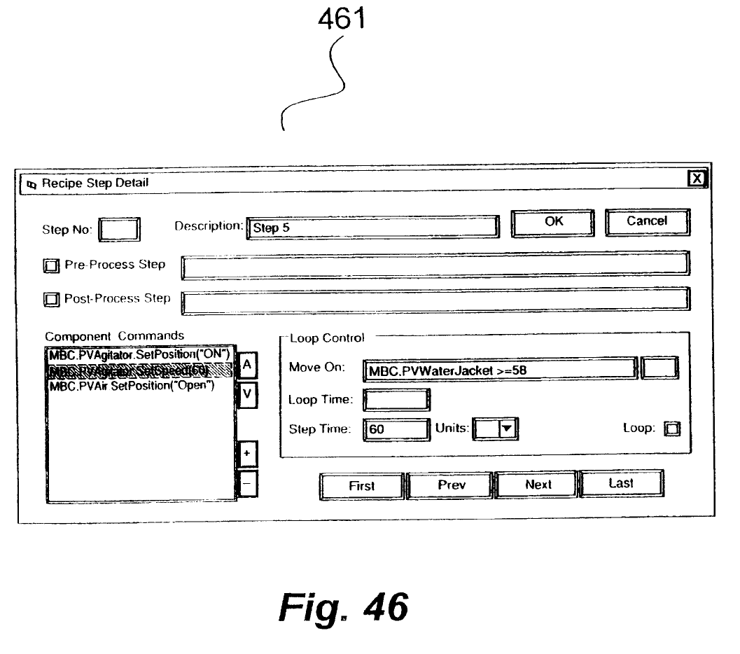

From within, or without, the component explorer, and/or the component selector or browser, a recipe may be edited. A recipe may be edited, for example, through the use of a recipe editor 451, such as that illustrated in the exemplary screen shot of FIG. 45. A step may be selected within the recipe editor, to which step a component is to be added. Upon selection of a given step, the components then involved in that step may be displayed, such as through the use of a treed menu. Further, selected aspects of that step and/or those components, may be displayed. Further, upon selection of a step, a step detail window may be available, as, for example, a pop-up window, or a selectable display window from, for example, a file menu or a hyperlink. Upon selection of a step detail window 461, such as that illustrated in exemplary screen shot of FIG. 46, numerous aspects of the step may be illustrated. These aspects may include, for example, components included in the step, component commands included in the step, the number of the step, pre and post processing for the step, loop control for the step, and the ability to move, within the step detail window, between steps. It may also be allowable to enable and/or disable recipe steps, such as from within the recipe step detail. Further, multiple recipe steps may be block selected by methodologies apparent to those skilled in the art.

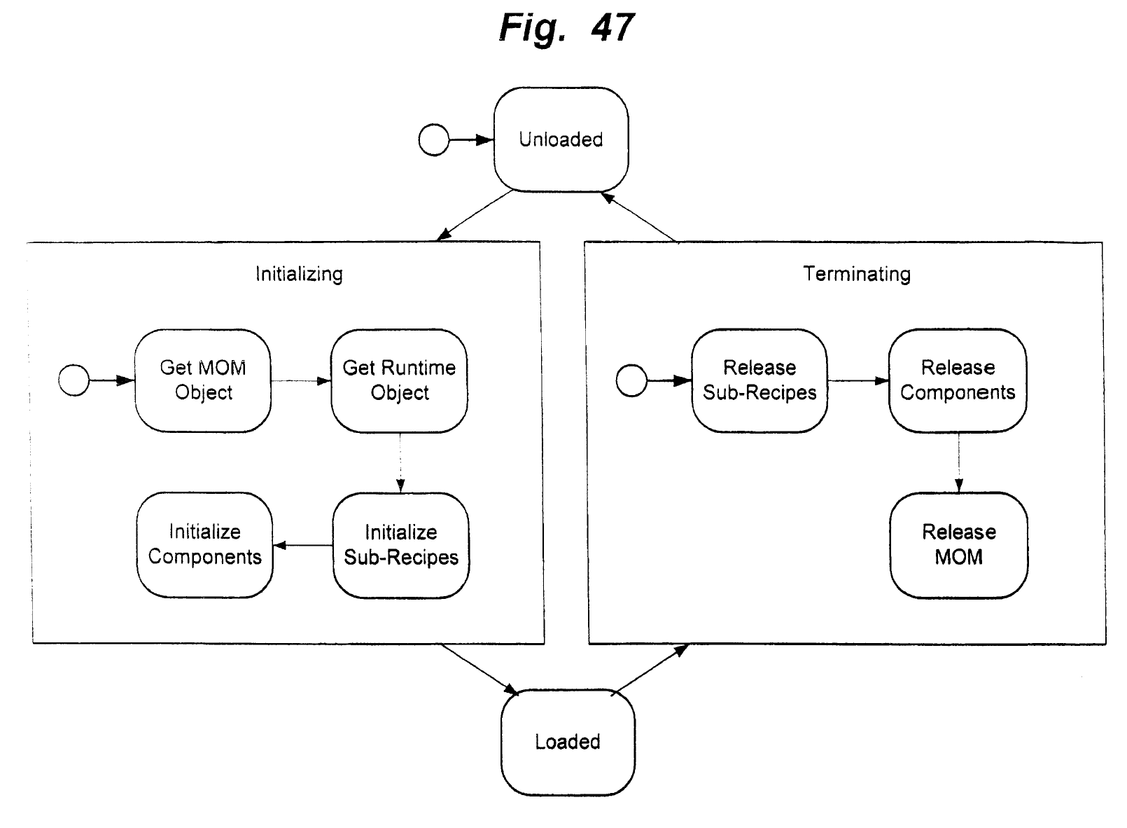

In an exemplary embodiment of execution of run-time for model based control, FIG. 47 is a state diagram illustrating a run-time condition for the model based controller. FIG. 47 illustrates the loaded and unloaded conditions for a run time object within the MBC. A run time object is initialized by obtaining, from MOM, as set forth hereinabove, the desired run-time object from a list of available run-time objects. Upon obtaining the run-time object, sub-recipes involving the run-time object, and components involved in the recipes and sub-recipes involving the run-time object, are initialized. The run-time is then loaded, the recipe and sub-recipes are run, and, upon meeting of the completion conditions, the recipe and/or sub-recipes are terminated by release of the sub-recipes, release of the component, and release of the MOM.

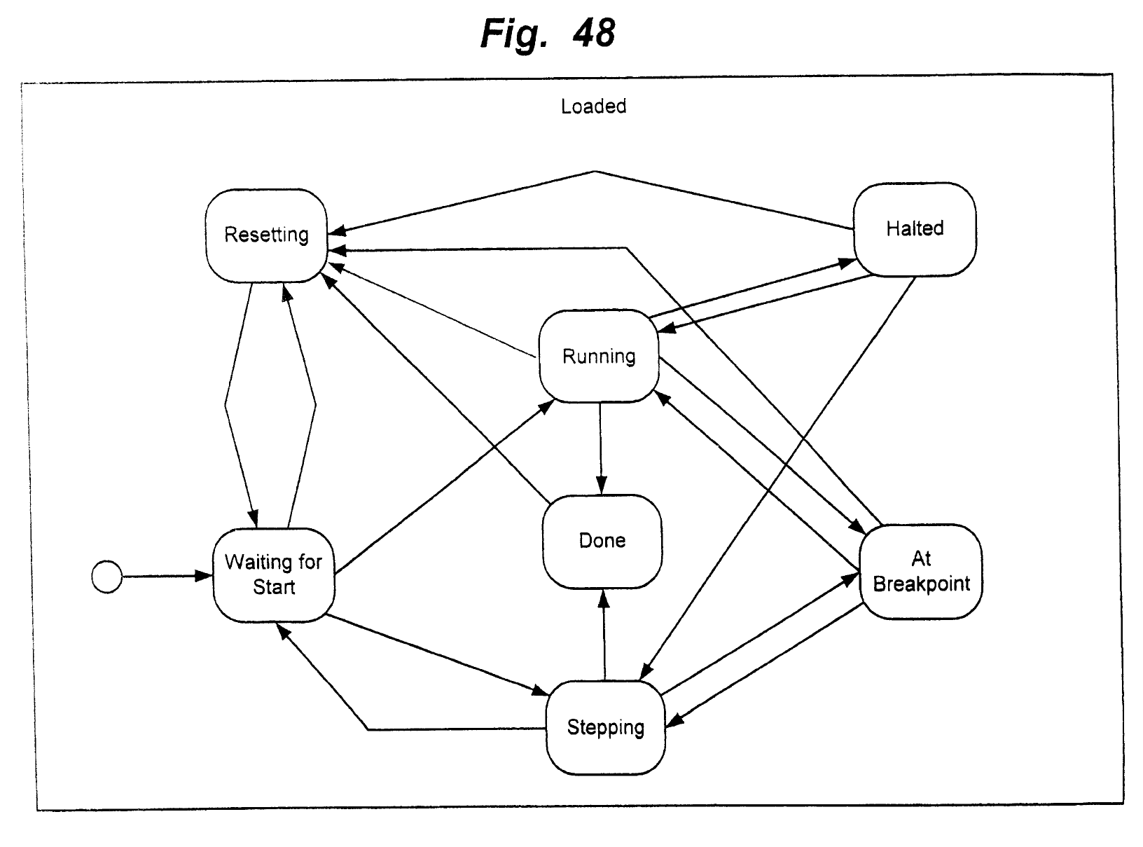

FIG. 48 is a state diagram illustrating a recipe at loaded state in the state diagram of FIG. 47. As illustrated in FIG. 48, the recipe may be in a waiting step, a resetting step, may be stepping, based on move on conditions, may be running through function calls relating to models and/or model components, may be at an end point or break point, may halt upon waiting for certain conditions, or upon reaching certain conditions, or may be complete. Upon “done” condition, the recipe may reset, and return to wait for start.

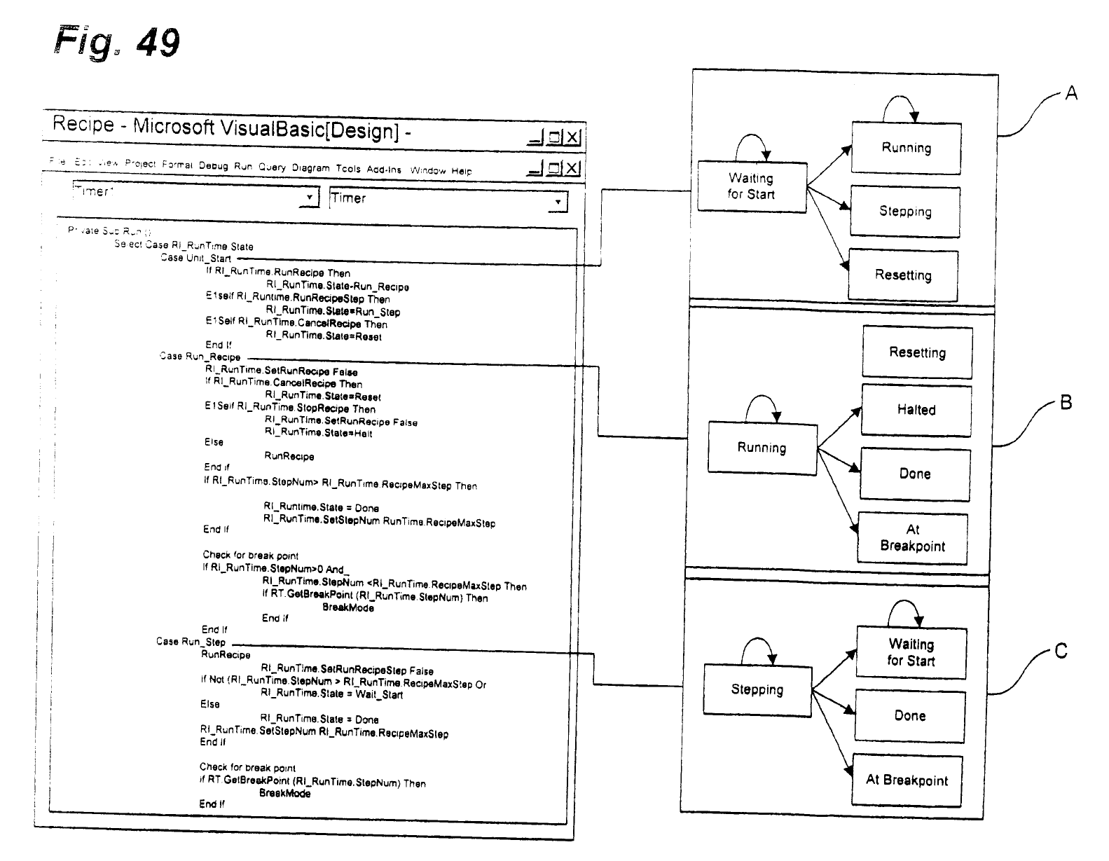

FIG. 49 is a screen shot of block code implementing the run time state diagram of FIG. 48. As illustrated, block A of the code waits for the start, and, upon receipt of an instruction to start, may run, continue running, step, or reset. The running block, as set forth above, may continue running, or may lead to a reset, halt, completion, or reaching of a set point or a break point. The stepping of code block C may pause to waiting for a start, completion, or reaching of a set point or break point that allows a step move on. As will be apparent to those skilled in the art, the code illustrated in the screen shot of FIG. 49 is exemplary only.

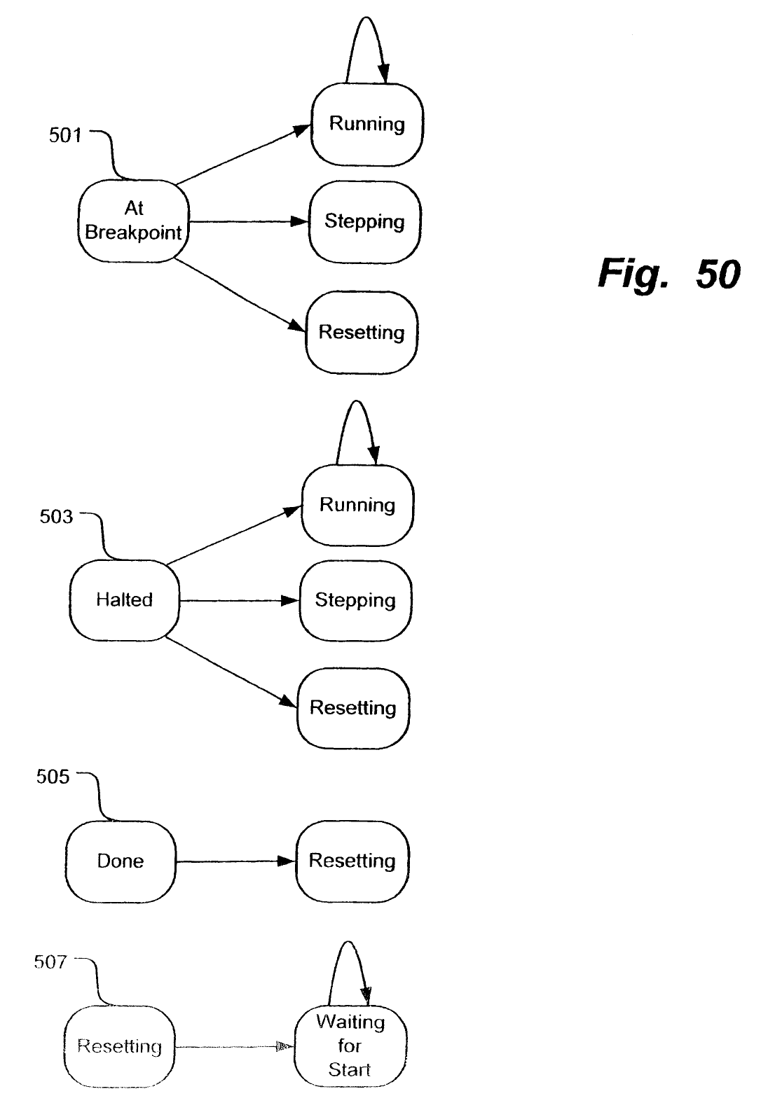

FIG. 50 is a flow diagram illustrating the break point 501, halting 503, completion 505, and resetting steps 507, in an embodiment of the diagram of FIG. 48. As illustrated, the reaching of a break point may cause the continued running of the recipe, a move-on step of the recipe, or the resetting of a recipe.

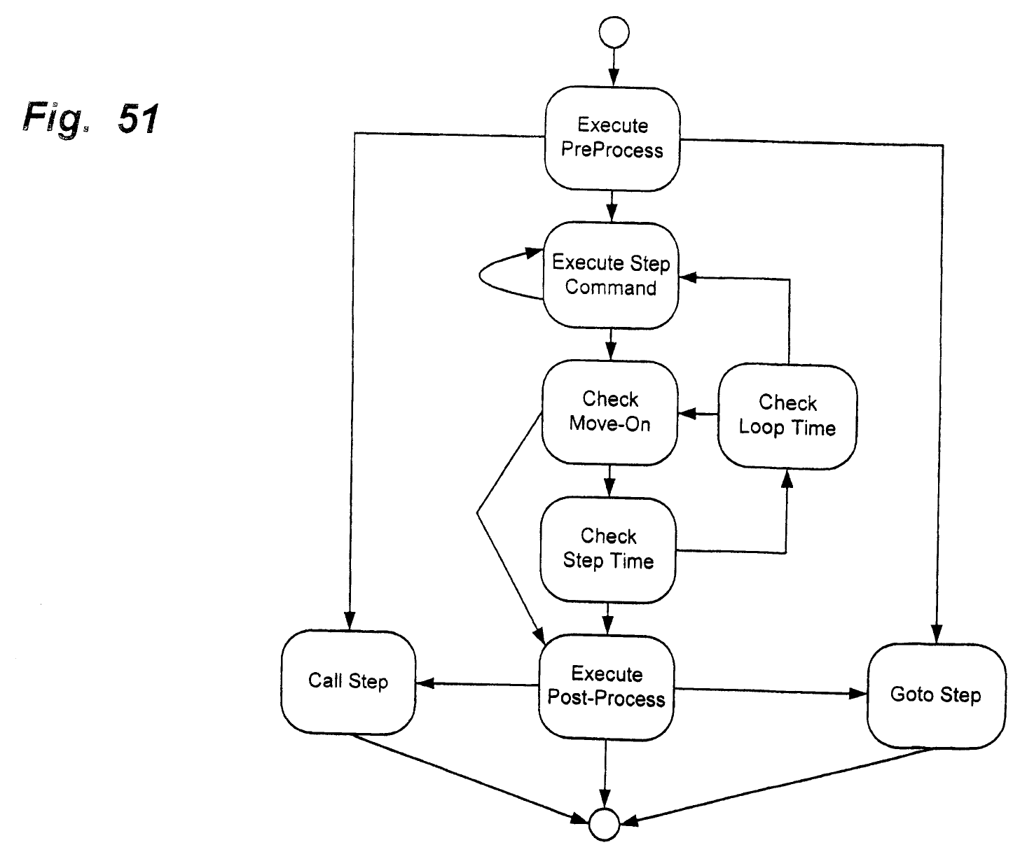

FIG. 51 is a state diagram specifically illustrating the step state of an exemplary MBC implementation. In the step state, pre-processed steps may be executed, and, upon implementation of an execute step command, which command may be looped repeatedly until execution occurs, the recipe repeatedly checks for a move-on condition, a stepping condition, a loop condition, or, upon execution of a step move-on, or end of step time, post-processing.

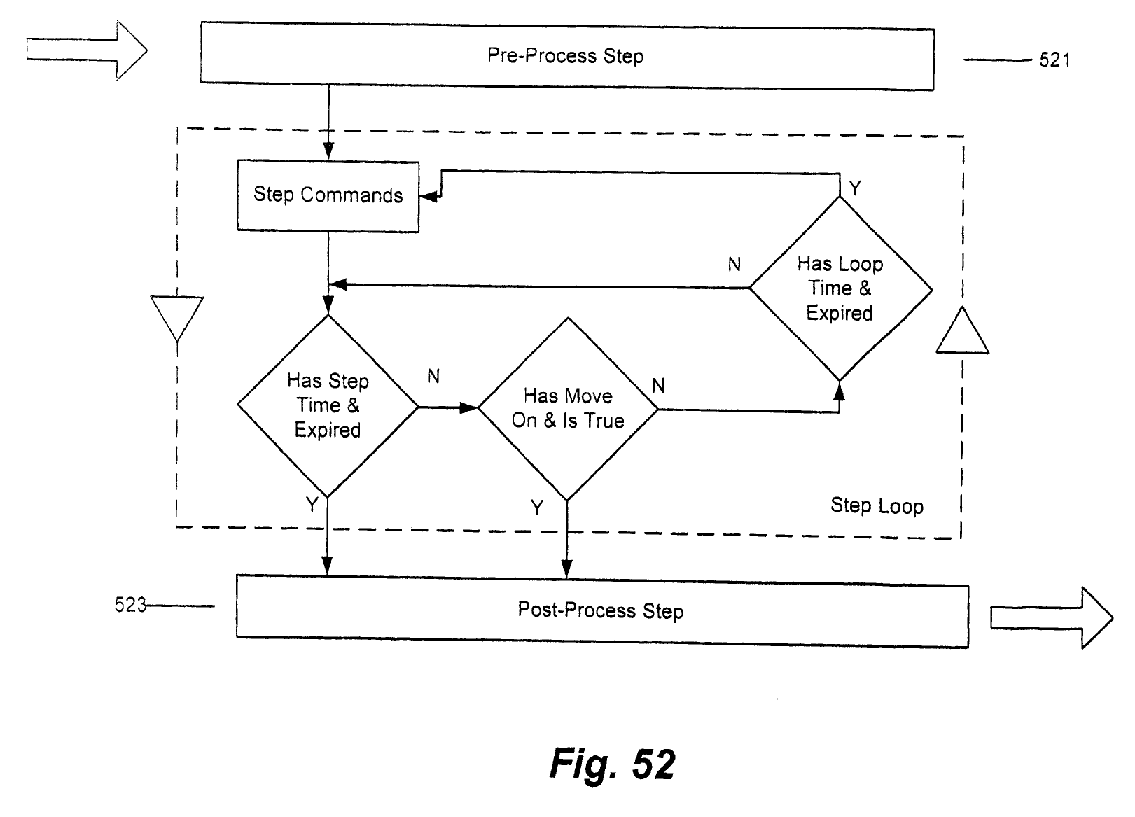

FIG. 52 is a flow diagram illustrating an exemplary implementation of the step state diagram of FIG. 51. In an embodiment, a step may be proceeded by pre-process step 521, and may be succeeded by a post process step 523. A step consist preferably of step function commands, and a step checks for, for example, whether a step time has expired, whether a move-on condition is met and/or true, and whether a loop, loop time, or loop condition, has been met.

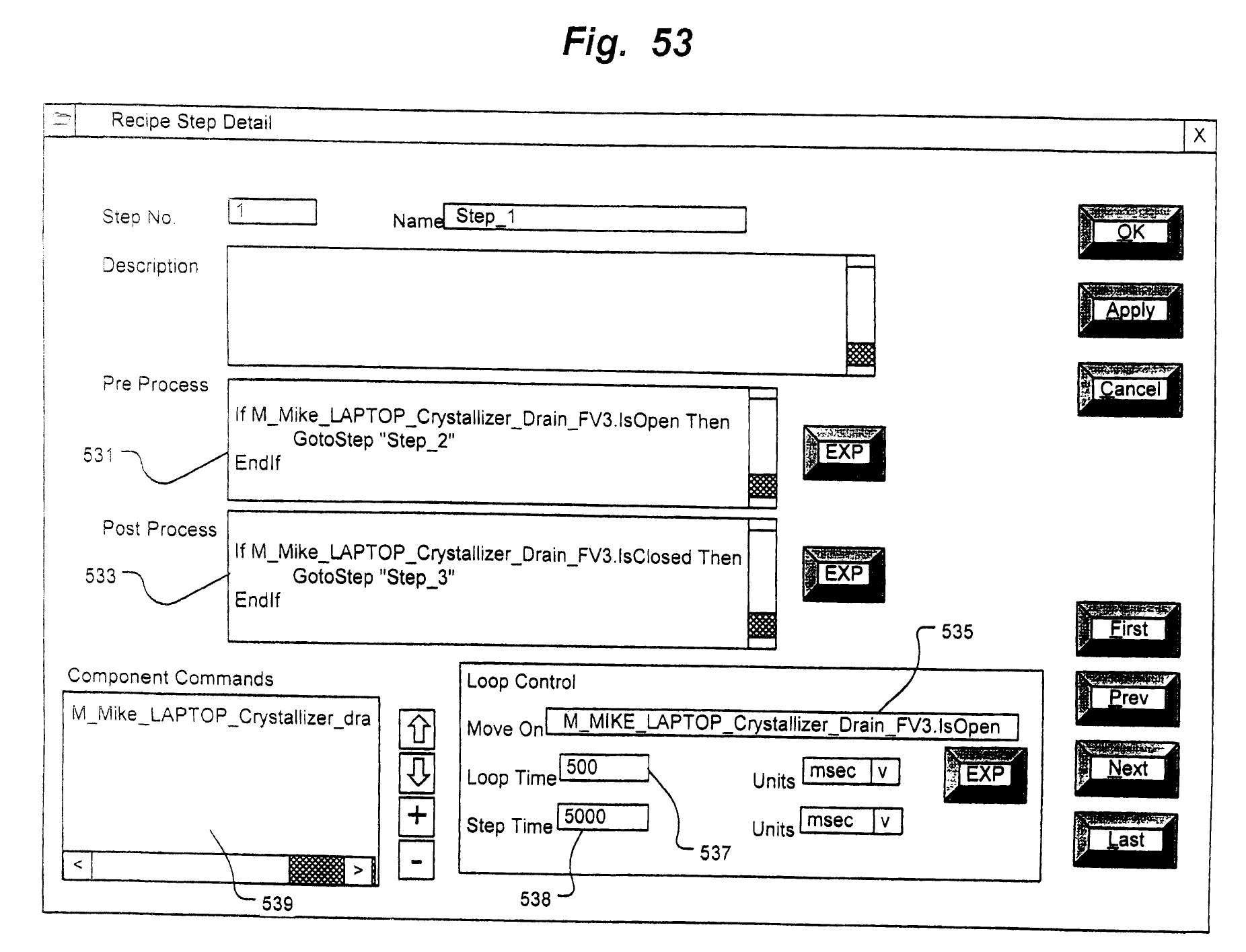

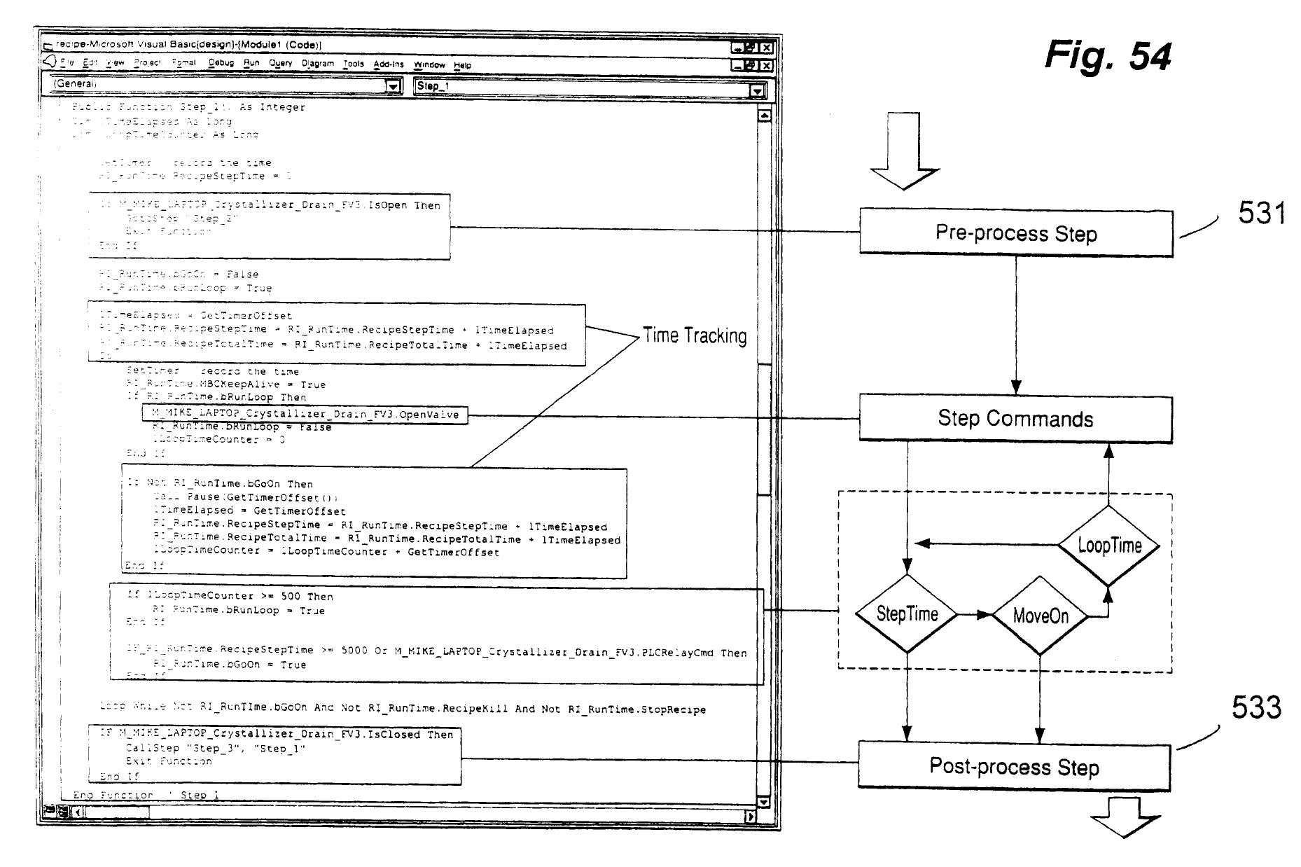

FIGS. 53 and 54 illustrate an exemplary embodiment of the flow diagram of FIG. 52. In the example, FIG. 53 illustrates a recipe step having a pre-process 531, a post-process 533, a move-on condition 535, a loop time 537, a step time 538, and step commands 539. FIG. 54 illustrates the breakdown of the code correspondent to the recipe step in FIG. 53, in accordance with the flow diagram of FIG. 52.

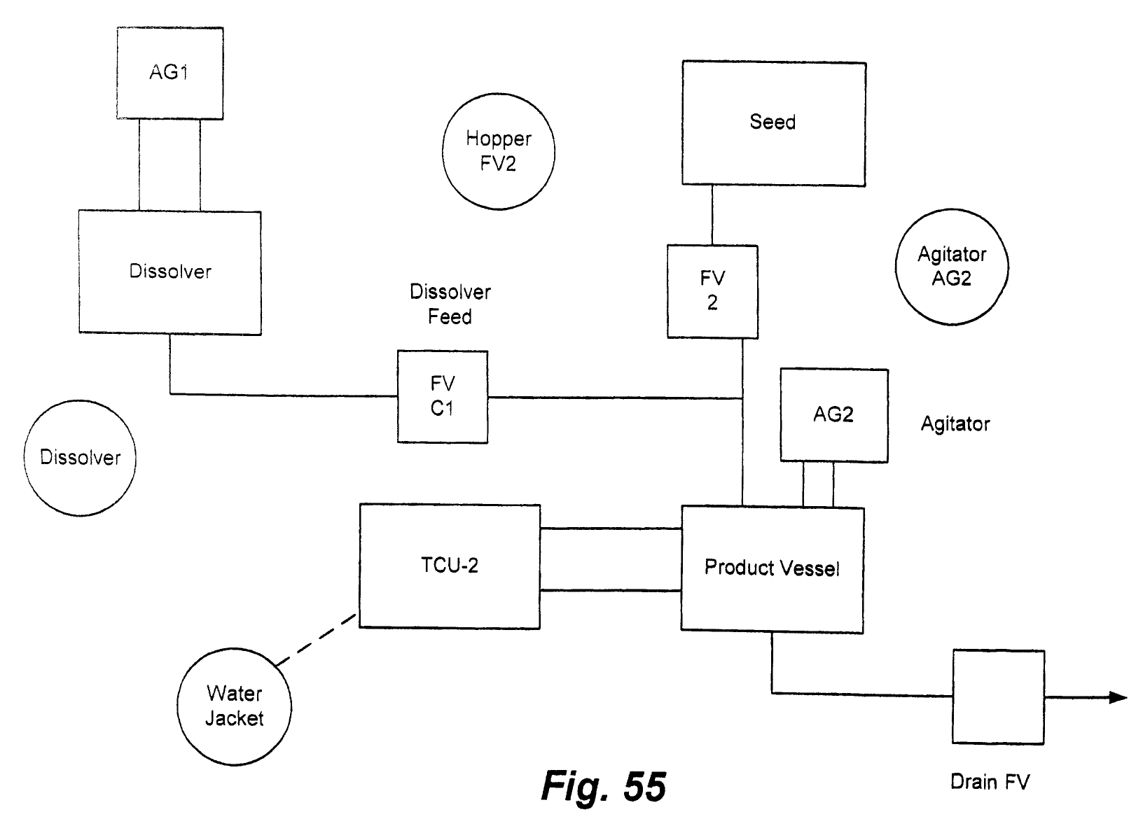

In a specific exemplary embodiment of the operation of a recipe on a component set, FIG. 55 illustrates a simple MBC recipe created around a particular hardware set, namely the crystallizer hardware discussed hereinabove with respect to the crystal growth model. Illustrated is a production vessel with an agitator and several valves that are feeding from either a dissolver or a hopper, and a temperature control unit maintaining the temperature of production vessel. For each piece of hardware, a component is created that represents the interface to that hardware. The illustrated recipe is to turn on the dissolver feed and set the flow rate to 3% open, open the hopper, turn on the agitator and wait for the speed to reach 88 rpms, and then turn on the water jacket temperature control unit and regulate to 55 degrees.

In the exemplary recipe of FIG. 55, each one of the components will execute the functions described in the recipe. In the first step in the illustrative recipe, the dissolver feed is turned on by setting the flow rate to 3, which is 3%. The hopper is opened by instructing the crystallizer hopper component to “open the valve.” The agitator is turned on by turning it “on,” setting the speed to 88 and not moving on from that particular step in the recipe until the speed reaches the speed set point. To set the water jacket temperature, it is turned “on,” the desired temperature is set to 55 degrees, the water jacket is given a flow rate of 1, and there is no move on until the vessel temperature hits the water jacket set point.

In an additional specific exemplary embodiment of hardware application of predictive modeling, the MBC may access and control at least one neural network, such as for use in an intelligent power plant (I PP) application The neural network(s) may perform as an optimizer that allows for predictive coordination of the multiple neural networks of the IPP, and a recipe template may allow for optimizing devices controlled by the neural network, as well as all components needed to create and control the devices, including the neural networks. The neural nets may be components, may be included in a library of neural net routine components, and may view inputs and outputs of other components, for example, to find optimal operations for those components in the given application, such as in the intelligent power plant, and the neural nets may suggest new control outputs for a controller of components in accordance with the optimization.

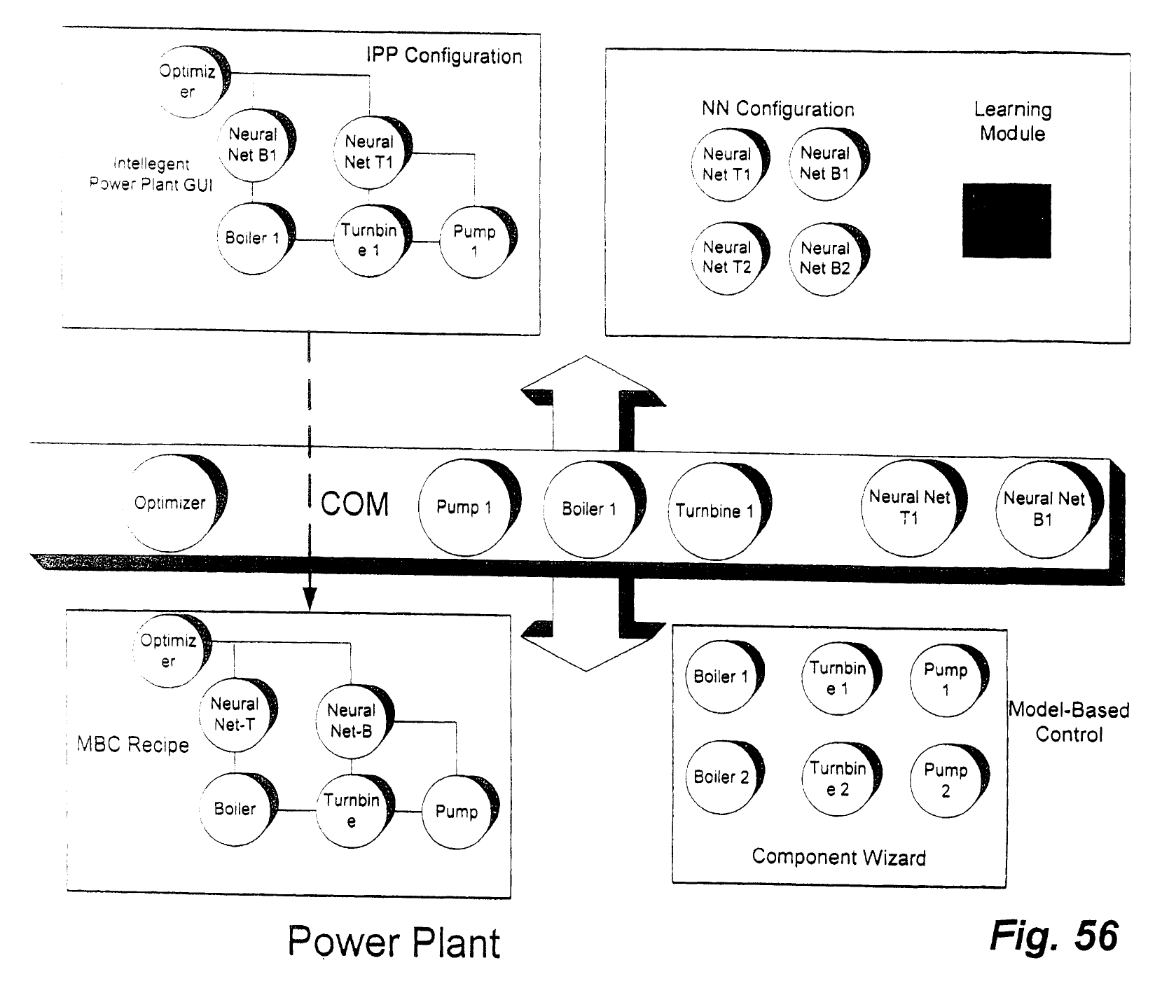

In a more specific exemplary intelligent power plant application 561, such as that of FIG. 56, the cogeneration of power is optimized based on the current fuel charges from the local power company. Parameters are reviewed, such as the time of day, the current solar input, whether students are on a campus controlled by the plant, and the number of classes that are open, and these inputs are used in a neural net to predict when cogeneration should happen. A GUI specific to a power plant operation may be designed in the MBC HMI, and may allow a plant operator to graphically describe the plant. The power plant GUI may allow for a manual interaction with an automatically generated series of neural net architectures, i.e. registered neural net components, to thereby create neural nets to do optimization of the specific plant.

In this embodiment, existing or known neural models, and other component models, such as IPP device and tool models, may be used and/or incorporated as MBC models, i.e., may be registered with the MBC as separate components. Each separate component may then be exposed to both the intelligent power plant, i.e. the controller inputs/outputs of the plant, and the MBC. The power plant is hierarchically below the MBC, so that the MBC components will direct the actual hardware of the IPP, and hence will direct the tools of the IPP. Inside an IPP tool, there may be several components that together create neural network optimization for that particular plant. The optimizer neural component may look at several neural nets, each of which neural nets may individually look at IPP tools or other IPP device components, to generate the optimum solution in relation to the other MBC components within a COM layer. Further, each neural net, and the optimizer neural net, may “learn” based on the behavior of the IPP when various performance characteristics of various IPP components are varied.

This learning module, the neural network, the IPP device components, and the neural net optimizer are preferably COM components. The component wizard discussed herein may create the actual device components within the COM layer, and make each accessible back to the IPP. The IPP may be subject to an MBC recipe that executes, in order, the component methods that need to be called to control and optimize performance of the IPP, based on present, prior, or projected performance of the IPP. The optimizer may run the neural networks, which may call directly the actual hardware components virtualized in the MBC. This MBC capability of generating a run time behavior and connecting it directly, and in real time, to the power plant greatly reduces development time. Thus, by using the component wizard to virtualize the device components of the IPP, and the neural net components, the MBC can talk to the power plant and the tools thereof, including during plant uptime.

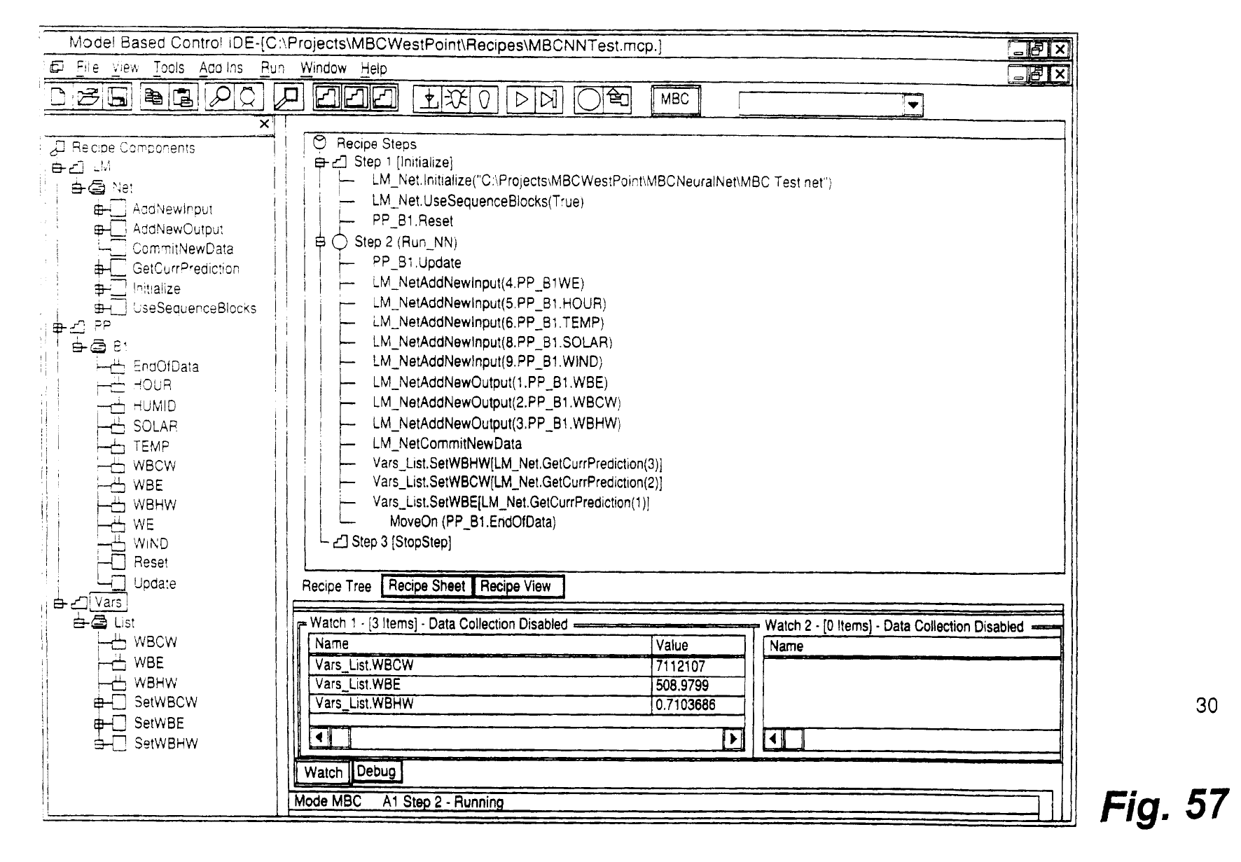

FIG. 57 illustrates an exemplary use of the neural network and power plant component. On the left hand side of the Figure is shown a learning module, a boiler represented by B1, and a view of the neural network suggesting a variable list at the bottom of several outputs. The neural network integration into the MBC allows it to be used as a separate component, independent of the IPP tools.

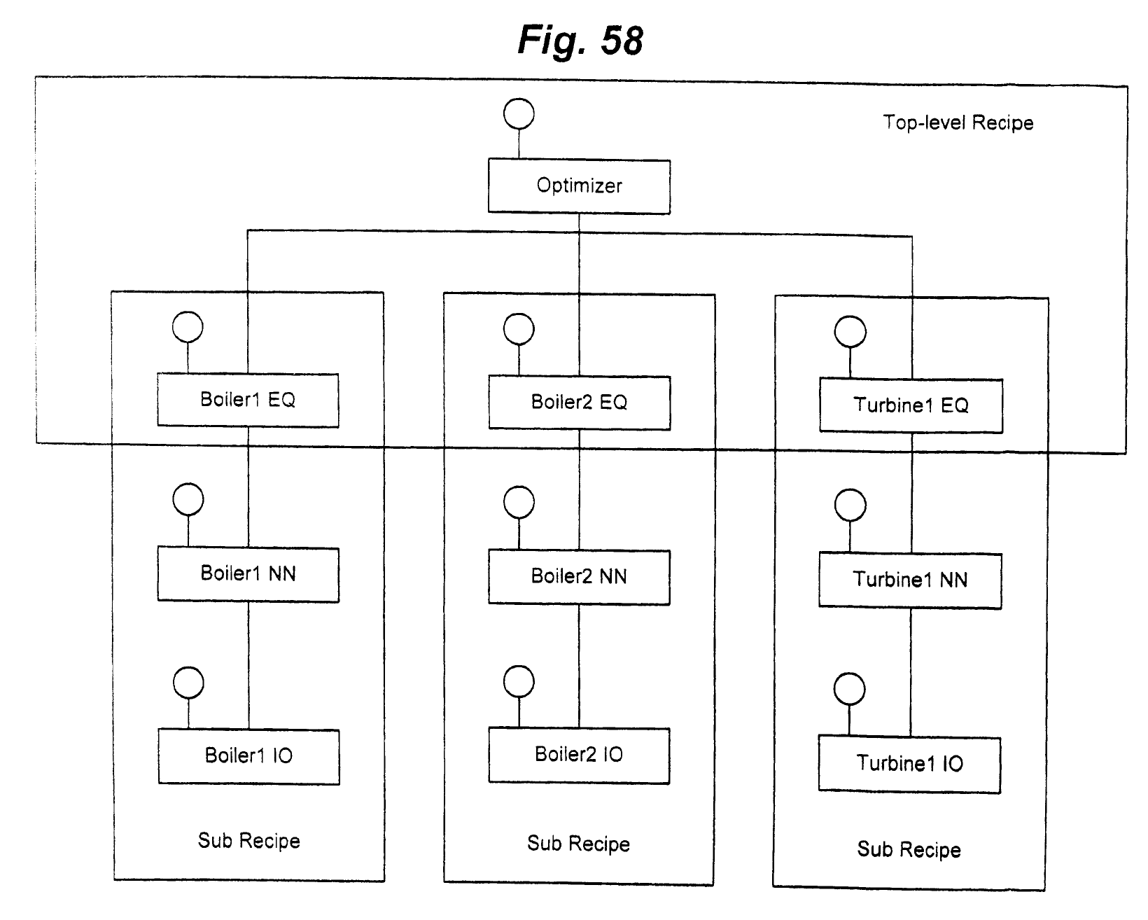

An MBC IPP framework is shown in FIG. 58, and the framework includes a top level recipe that contains an optimizer, and that coordinates with individual optimizers for IPP device components, namely two boilers and a turbine. The optimizers exercise neural network models that communicate to the MBC components that represent the actual boilers and the turbine. The behavior of the actual boilers and turbine is then controlled, based upon the modeling generated by the neural nets of the MBC, by the interfacing of the actual plant controllers to the MBC via COM. This framework allows devices and models to be duplicated when identified as needed for a given template. For example, only one virtualization of the boiler needs to be created in the above example, and the second boiler employed in the recipe(s) may simply be a copy of the registration of the first boiler.

The IPP architecture may use a recipe template for each piece of equipment in the plant requiring a neural network, and each such equipment piece may have a configuration including an I/O device component, a neural network component and an equipment component. The equipment component may be a unique recipe, for example, or may be incorporated into other recipes, such as neural net recipes, which may directly or indirectly control a unique equipment recipe. The neural net may be contained in a recipe with configuration data, and the I/O configuration within each component, and within each recipe, may define the connection from that MBC component to the actual device.

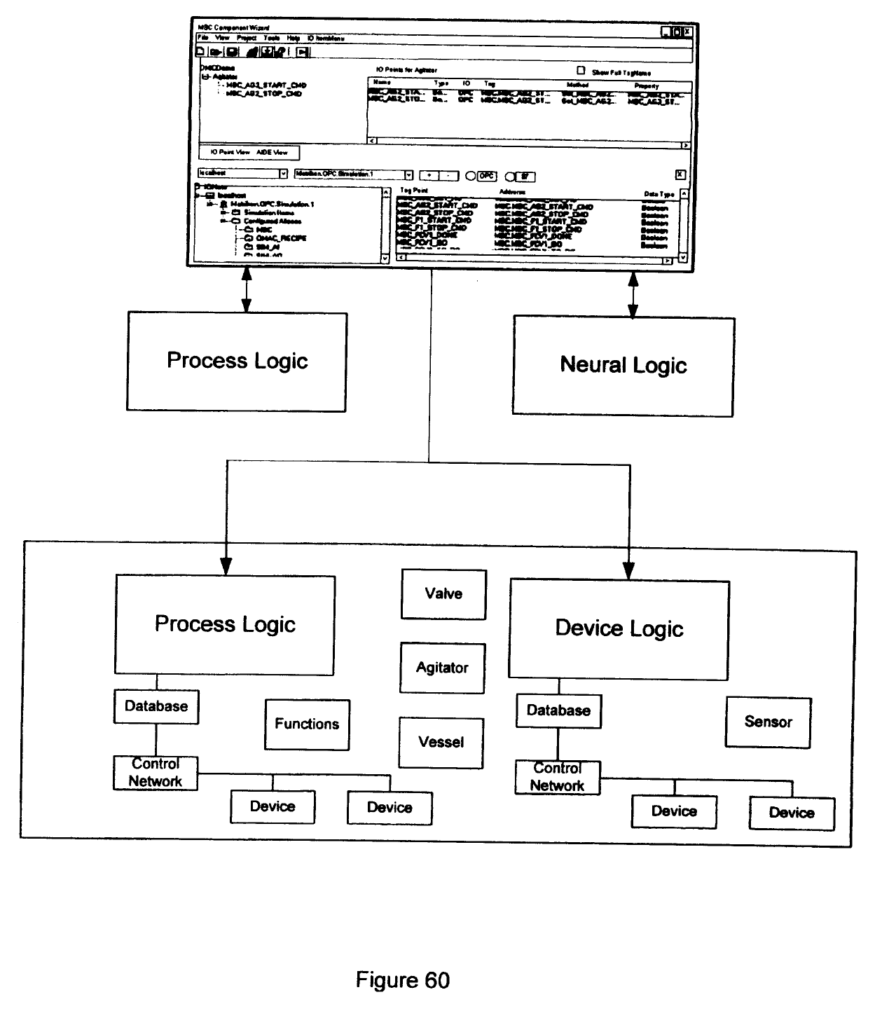

FIG. 60 illustrates a more specific exemplary embodiment wherein an exemplary plant is made up exclusively of Siemens' controllers. These may be, for example, programmable logic controllers that go out within the exemplary plant and ultimately connect, directly and indirectly, through a control network to all of the various devices in the plant. The device logic for all of these devices is thus within the PLC logic. The device logic may be, for example, programmed in ladders, or sequential function charts, as is known in the art. Device logic may represent, for example, the manner of controlling an agitator, or a valve, but typically does not represent a learning, i.e. a neural, device logic, because adjustments on-the-fly are typically not available due to the sequential program nature of the Siemens' PLCs.

Also within the illustrated PLC logic is the master process logic for how to manufacture particular product, for example. Process logic may include the timing, the valve setting, the agitation speeds, the temperatures, etc., and the necessary adjustments thereto when one such element is modified, to the extent such adjustments are known at the time of the PLC programming. However, the MBC component wizard may interrogate existing controllers and give a list of the devices controlled thereby, as discussed hereinabove. The component wizard may create a virtual set of devices that represent the interrogated devices by the tag points thereof. The component wizard may then present these virtual devices back to the MBC executor, such as for operation on those components of neural logic programmed into the MBC on-the-fly.

In the MBC, the process logic, supervisory and neural logic, and all of the data from the individual components (devices) is collected and archived, both by device and by process, for operation on those devices and processes by new models programmed into the MBC, such as neural logic models. For example, multiple processes may be occurring within this exemplary plant, such as the generation of power from a generator, and an intake of fuel. This data and these processes can then be used to develop models for use in the MBC, either by manual interaction of automated generation of model devices and model recipes by assessment of the PLC tag points by the component wizard. These models become components within the system, and can be represented in the process logic to allow use of these models in making plant-related decisions, such as assessing when power generation has dipped below a certain level, and what algorithms must be employed to make up the power shortfall from a third-party generator, and a real time assessment of which third-party generator is best suited, such as by cost-assessment, to make up the shortfall at that time.

Thus, without changing the existing plant or the MBC, third party aspects and technology, such as a new on-line process sensor, or learning control based on algorithmic modeling of process inputs, may be seemlessly introduced to the existing control system to optimize processes. Such third party aspects are thus available to the process engineer, from within the MBC, as a device and/or a model to optimize or to fix a particular problem without reprogramming of PLCs or the like. Thus, the connection to the physical plant can be broken and moved to another plant simply by reconfiguring the device types within the MBC that the model components attach to.

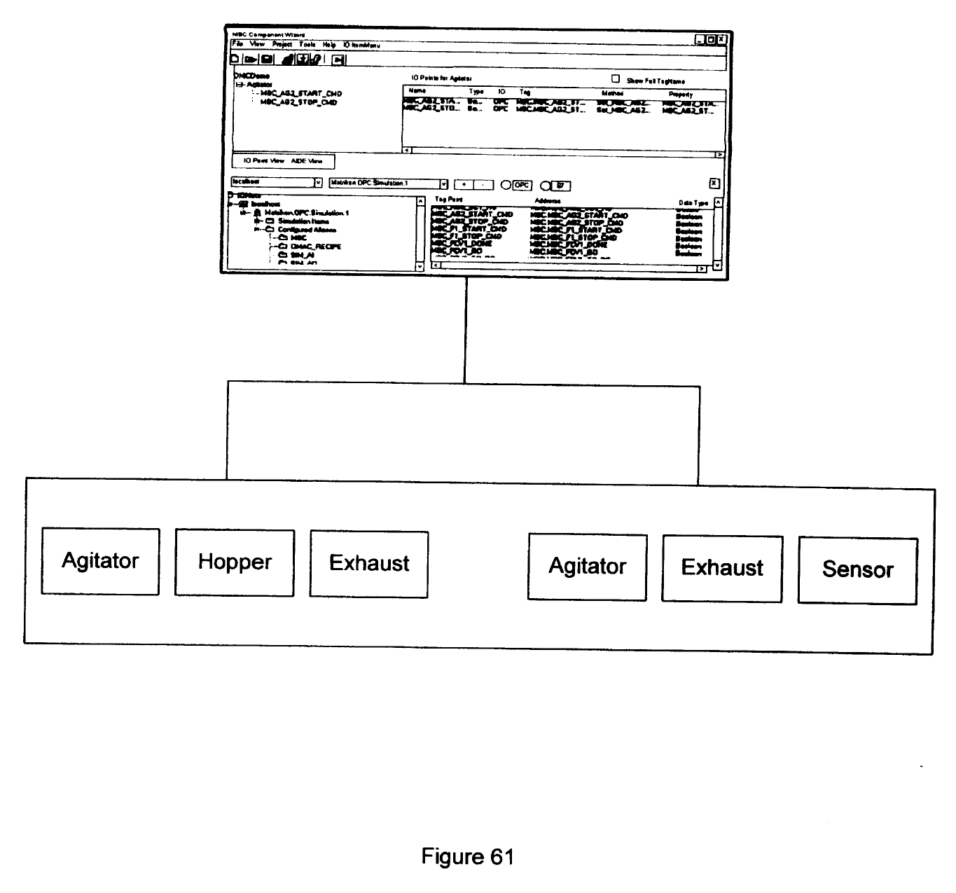

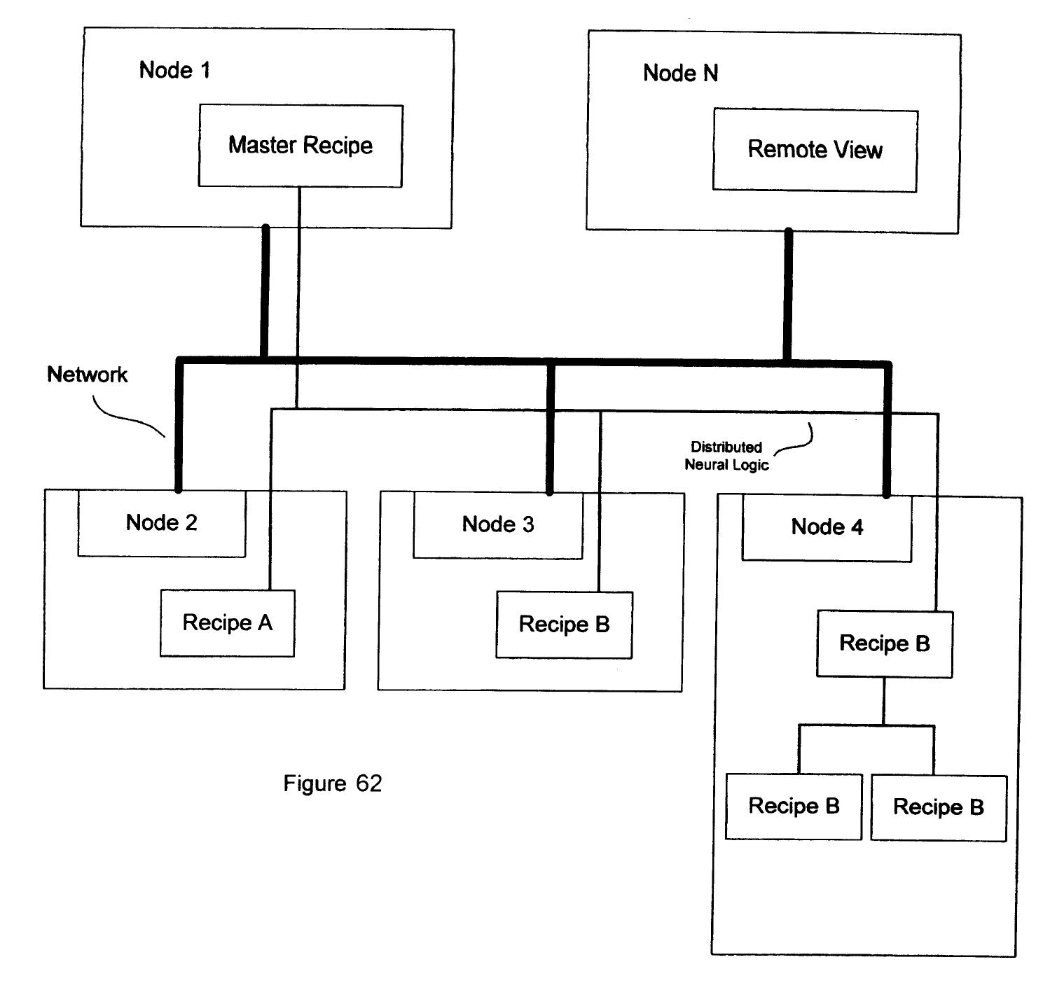

As illustrated in FIG. 61, the specific exemplary plant may include an existing network of computers, nodes, testing facilities, and work cells within the floor, or on different floors. The MBC can be applied to particular nodes to control, for example, an individual work cell, and the active recipes on those individual nodes may be remotely viewable from anywhere on the network. For example, as illustrated in FIGS. 61 and 62, data may come from a recipe testing on node 2, or from a pre-process node 3, that may affect the process on node 4, and the master recipe may be resident on a supervisory node 1 coordinating the entire process. Each node may be available through a remote viewer from anywhere within the plant, or from anywhere over the network Thus, MBC provides distributed control over networks of controllers to control a plant, and allows for distributed input of, for example, neural processes to control the networks of controllers. Thereby, individual plants, or controllers, may go on and off line, such as to allow for repair of a particular problem, or a change of the logic of control, while the rest of a system may continue normal running, and while a distributed neural network may make real time adjustments to account for off-line system aspects.

As illustrated in FIG. 62, and in order to allow for neural network processing, the MBC tools may automatically capture and archive, for each batch or manufacturing run, process data for every component throughout the system, the process and neural logic used to create that particular batch, process variables, process parameters, and set points placed, before logic is run. Thus, models can compare networks against data to do regression studies, and automatically configure and train neural network models to interactively create process optimization models. Thereby, if a batch or product fails, it can be correlated back to the process. More importantly, if a product is effective, it can be reproduced by the precise actual logic process parameters used to make that particular product the first time.

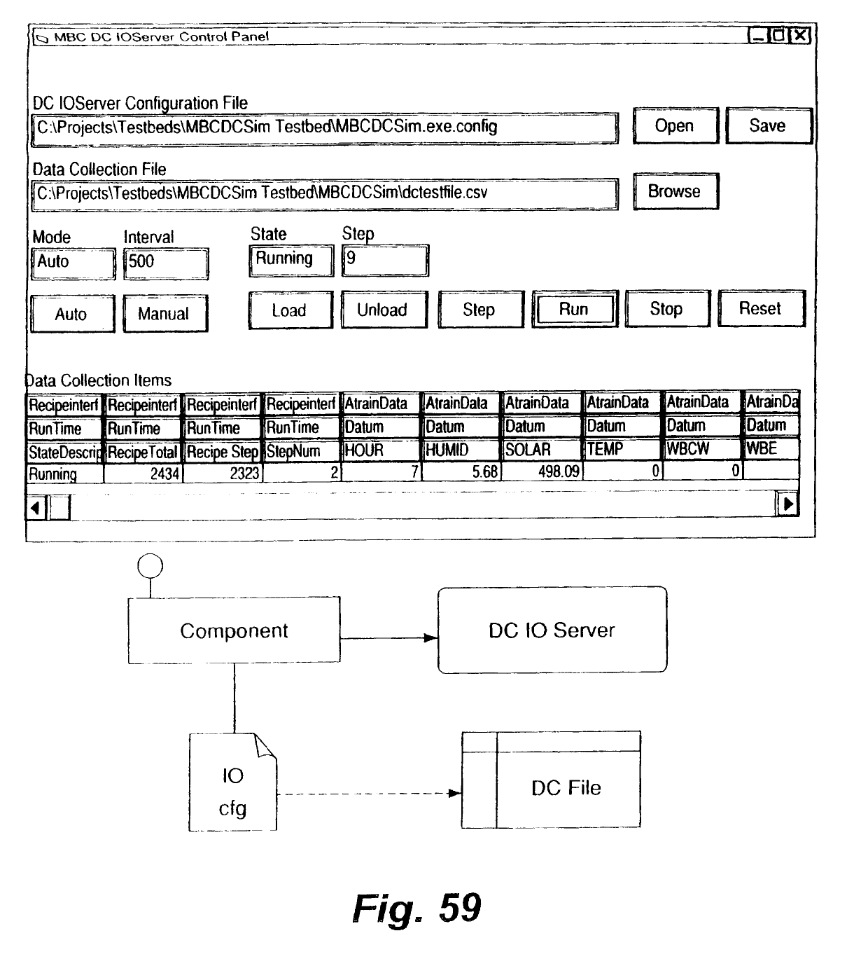

Data collection may be provided for each individual component. At the bottom of the illustration in FIG. 59 is shown a component with an I/O configuration that may first connect to a device on a particular controller, and that may then gather the information related to that device. Gathered data may be played back as simulation without the recipe being effected. Thus, the MBC component may play back historical data, such as with existing MBC components and recipes, to allow the observance of the controller running, and to thereby allow for development of models against data observed.

Those of ordinary skill in the art will recognize that many modifications and variations of the present invention may be implemented. The foregoing description and the following claims are intended to cover all such modifications and variations.

What is claimed is:

1. A model based controller system for controlling at least one neural network, comprising:
a plurality of models, wherein said plurality includes at least one modeled component, at least one recipe model, and at least one optimizer model, and wherein each of said at least one modeled components is corresponded to each of the at least one devices for control and is communicatively connected to at least one of said at least one recipe models, and wherein each of said at least one optimizer models monitors at least one of said at least one recipes and at least one of said at least one modeled components;
an executor resident above said plurality that coordinates at least one of the modeled components with at least one of the recipes to provide for virtual control, and that monitors said at least one optimizer for neural input to modify the virtual control; and
at least one interface that communicatively connects the executor to each of the at least one devices for control.

2. The system of claim 1, wherein said optimizer model comprises a predictive coordinator of the at least one recipe models.

3. The system of claim 3, wherein the predictive coordinator suggests new control outputs from the at least one recipe model in accordance with a prediction for optimization.

4. The system of claim 1, wherein each of the at least one recipes control at least one power plant.

5. The system of claim 4, wherein the at least one optimization model optimizes cogeneration of power based on current fuel charges from a local power company.

6. The system of claim 5, wherein the optimization model optimizes based on at least one selected from the group consisting of time of day, current solar input, and persons receiving power from the at least one power plant.

7. The system of claim 1, wherein the at least one optimization model learns improvements to optimization by monitoring performance of at least one of the devices for control when the virtual control is varied.

8. The system of claim 1, wherein each of the at least one device for control and the neural inputs comprise COM components.

9. The system of claim 1, wherein the optimization model optimizes based on one selected from the group consisting of present, prior, or projected performance of the at least one device for control.

10. The system of claim 1, wherein at least one of said optimizer models is corresponded to one of said modeled components.

11. The system of claim 10, wherein the corresponded ones of said optimizer models are controlled by a master one of said optimizer models.

12. The system of claim 1, wherein each of the at least one device for control comprises an I/O device component for receiving signals corresponded to the virtual control, a neural network component for receiving signals corresponded to the nueral inputs, and an equipment component for taking action in accordance with the virtual control.

13. The system of claim 1, wherein said at least one recipe model includes a process logic for operation of at least a portion of the at least on neural network and a device logic for control of the at least one device for control.

14. The system of claim 13, wherein said at least one optimizer models includes a process logic optimizer for optimizing the process logic, and a device logic optimizer for optimizing the device logic.

15. The system of claim 14, wherein the process logic comprises at least one selected from the group consisting of timing, settings, speeds, adjustments, and temperatures.

16. The system of claim 1, wherein said interface communicates the virtual control to the at least one device for control via a plurality of tag points correspondent to aspects of the at least device for control.

17. The system of claim 1, wherein data individually correspondent to each of the at least one devices for control is collected and archived in said executor.

18. The system of claim 1, wherein data individually correspondent to each process correspondent to each of said at least one recpe models is collected and archived in said executor.

19. The system of claim 1, wherein said at least one recipe model comprises at least two recipe models, and wherein a first of the at least two recipe models supervises a second of the at least two recipe models, and wherein each of the first recipe model and the second recipe model are on different nodes.

20. The system of claim 19, further comprising a remote viewer, wherein each of the different nodes is viewable on at least one of said at least one remote viewer.

21. The system of claim 1, wherein said at least one optimizer model comprises at least two optimizer models, and wherein a first of the at least two optimizer models supervises a second of the at least two optimizer models, and wherein each of the first optimizer model and the second optimizer model are on different nodes.

22. The system of claim 21, further comprising a remote viewer, wherein each of the different nodes is viewable on at least one of said at least one remote viewer.

23. The system of claim 1, wherein said executor archives at least two selected from the group consisting of process data each of the devices for control, process logic for the virtual control, process variables for the virtual control, process parameters for the virtual control, and set points placed for the virtual control.

24. The system of claim 1, wherein said at least one interface engages actual control of the at least one device for control in accordance with the virtual control.
